(19) United States
(12) Patent Application Publication
(10) Pub. No.: US 2024/0278084 A1
(43) Pub. Date: Aug. 22, 2024

(54) BASKETBALL

(71) Applicant: Wilson Sporting Goods Co., Chicago, IL (US)

(72) Inventors: Nadine Lippa, Arlington Heights, IL (US); Hudson R. Vantrease, Chicago, IL (US); Kevin L. Krysiak, Palatine, IL (US); David A. Vogel, Island City, IL (US); Ninad Trifale, Chicago, IL (US)

(73) Assignee: Wilson Sporting Goods Co., Chicago, IL (US)

(21) Appl. No.: 18/434,727

(22) Filed: Feb. 6, 2024

Related U.S. Application Data
(60) Provisional application No. 63/446,801, filed on Feb. 18, 2023.

(51) Int. Cl. A63B 37/12; A63B 41/02

(52) U.S. Cl. CPC A63B 37/12; A63B 41/02; A63B 2209/00; A63B 2243/0037

(57) ABSTRACT

A basketball may include a single integrally formed unitary body having a first layer comprising an inner lattice, second layer having an outer lattice and surface strips, and radial beams interconnecting the first layer and the second layer.

### BACKGROUND

Basketball is a popular support worldwide. Basketballs are typically formed by an inflatable bladder wrapped in layers of fibers and overlaid with leather or rubber composite panels. Some basketballs are formed by a molded rubber sphere.

### BRIEF DESCRIPTION OF THE DRAWINGS

FIG. 1 is a perspective view of an example basketball.

FIG. 2 is an end view of the example basketball of FIG. 1.

FIG. 3 is a side view of the example basketball of FIG. 1.

FIG. 4 is a sectional view of the example basketball of FIG. 3 taken along line 4-4.

FIG. 5 is a sectional view of the example basketball of FIG. 2 taken along line 5-5.

FIG. 6 is an enlarged perspective view of a portion of the example basketball of FIG. 5.

FIG. 6 is an enlarged perspective view of a portion of the example basketball of FIG. 2.

FIG. 8 is a fragmentary sectional view of the example basketball of FIG. 1, wherein portions of a wall of the basketball are omitted to illustrate an inner surface of an outer layer of the basketball.

FIG. 9 is an enlarged sectional view of a portion of the example basketball of FIG. 1.

FIG. 10 is an enlarged perspective view of a portion of the example basketball of FIG. 1.

FIG. 11 is an enlarged view of a portion of the example basketball of FIG. 10.

FIG. 12 is an enlarged sectional view of a portion of the basketball of FIG. 1.

FIG. 13 is an enlarged sectional view of a portion of the basketball of FIG. 1.

FIG. 14 is an enlarged perspective view of a portion of the basketball of FIG. 1.

FIG. 15 is an enlarged sectional view of a portion of the basketball of FIG. 1, illustrating an outer wall having a loby-flat construction having an inner layer and an outer layer joined by radial beams.

FIG. 16 is an enlarged sectional view of a portion of the basketball of FIG. 1 with a different inner layer to provide the outer wall with a loby-loby construction.

FIG. 17 is an enlarged sectional view of a portion of the basketball of FIG. 1 with a different inner layer and a different outer layer provide the outer all with a flat-flat construction.

FIG. 18A is an enlarged perspective view of a portion of the basketball of FIG. 1.

FIG. 18B is a sectional view illustrating the example outer circumferential beams of an outer lattice of an outer layer of the outer wall of the basketball of FIG. 1.

FIG. 19 is an enlarged perspective view of a portion of a basketball having outer circumferential beams of an outer lattice of an outer layer of an outer wall, wherein the outer circumferential beams have outer rounded surfaces.

FIG. 20 is a perspective view of a portion of an example basketball having an outer lattice that is textured.

FIG. 21 is a perspective view of a portion of example basketball having surface strips that are textured.

FIG. 22 is a top view of the front from a pole and) of the example basketball of FIG. 1 without an outer layer to illustrate a varying thickness of radial beams about the basketball, wherein the varying thicknesses are indicated by a heat map of the thicknesses.

FIG. 23 is an enlarged perspective of the example basketball of FIG. 22.

FIG. 24 is a side view of the first side of the example basketball of FIG. 22.

FIG. 25 is a side view of a second opposite side of the example basketball of FIG. 22.

FIG. 26 is a perspective view of an example basketball omitting an inner layer and an outer layer of an outer wall, wherein radial beams having varying thicknesses are illustrated with an associated heat map indicating the varying thicknesses of the radial beams.

FIG. 27 is an enlarged perspective view illustrating portions of an example basketball without an outer layer of the outer wall to illustrate example radial beams extending from an example inner layer of the outer wall.

FIG. 28 is an enlarged perspective view illustrating portions of an example basketball without an outer layer of the outer wall illustrate example radial beams extending from an example inner layer of the outer wall.

FIG. 29 is a top view (taken from a pole and) of an example basketball omitting an outer layer and portions of an inner layer of the outer wall, while illustrating an example inner skeleton and an example distribution of radial beams, wherein varying thicknesses of the radial beams are indicated by a heat map.

FIG. 30 is a perspective view illustrating the example basketball of 1 having a first information landing.

FIG. 31 is an enlarged perspective view of a portion of the example basketball of FIG. 30.

FIG. 32 is an enlarged perspective view of a portion of the basketball of FIG. 30 having an example second information landing.

FIG. 33 is an enlarged perspective view of a portion of the example basketball of FIG. 32 illustrating the example second information landing.

FIG. 34 is a perspective view of the example basketball of FIG. 30 having an example third information landing.

FIG. 35 is an enlarged perspective view of a portion of the basketball of FIG. 34 illustrating the example third information landing.

FIG. 36 is a perspective view of the example basketball of FIG. 30 having an example a fourth information landing.

FIG. 37 is an enlarged perspective view of a portion of the basketball of FIG. 36 illustrating the example fourth information landing.

FIG. 38 is an enlarged perspective view of portions of the example basketball of FIG. 1 having an example information incorporated into and outer lattice of the example basketball.

FIG. 39 is a perspective view illustrating portions of the example basketball of FIG. 1 having an example information coating.

FIG. 40 is a perspective view illustrating an example method for printing the example basketball of FIG. 1.

FIG. 41 is a sectional view schematically illustrating the example basketball formed by the example basketball of FIG. 1 having an example outer skin.

FIG. 42 is a sectional view illustrating portions of the example basketball of FIG. 41 with the example outer skin.

FIG. 43 is a sectional view illustrating portions of the example basketball of FIG. 41 with an alternative outer skin.

FIG. 44 is a sectional view illustrating portions of the example basketball of FIG. 41 with an alternative outer skin.

FIG. 45 is a sectional view illustrating portions of an example basketball formed by the example basketball of FIG. 1 and provided with an example inner skin.

FIG. 46 is a sectional view of a portion of the example basketball of FIG. 45 with the example inner skin.

FIG. 47 is a sectional view of a portion of the example basketball of FIG. 45 with an alternative inner skin.

FIG. 48 is a sectional view schematically illustrating portions of an example basketball formed by the example basketball of FIG. 1 and provided with an example middle skin.

FIG. 49 is a sectional view of a portion of the example basketball of FIG. 48 with the example middle skin.

FIG. 50 is a sectional view of a portion of the example basketball of FIG. 48 with an alternative middle skin.

FIG. 51 is a sectional view schematically illustrating portions of an example basketball formed by the example basketball of FIG. 1 and provided with the outer skin of FIG. 42 and the inner skin of FIG. 46.

FIG. 52 is a sectional view of the example basketball taken along line 51-51 of FIG. 51.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example basketballs formed by additive or 3D printing. The example 3D printed basketballs are formed from materials and have features that provide the basketballs with the outer surface strips that basketball players are accustomed to when handling and gripping the basketball. At the same time, the 3D printed basketballs have a size, weight, and rebound consistency similar to that of standard or conventional competitive play basketballs currently sanctioned by various organizations such as the National basketball Association (NBA), National Collegiate Athletic Association (NCAA), National Federation of High Schools (NFHS) and other organizations. In contrast to such standard or conventional competitive play basketballs, the disclosed 3D printing basketballs offer a unique aesthetic.

In some implementations, the example 3D printed basketballs are a single integral one-piece construction. The one-piece construction reduces the number of parts and may simplify assembly. In some implementations, the example 3D printed basketballs may largely comprise a one-piece construction, but wherein an outer, inner or middle skin is provided to reduce airflow resistance when the ball is shot or passed.

In some implementations, the 3D printed basketballs do not require inflation. As result, the task of maintaining the basketball at a proper inflation level or pressure is eliminated. In addition, rebound performance of the 3D printed basketballs may be more consistent over time.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

FIGS. 1-3 illustrate an example basketball 20. In the example illustrated, basketball 20 comprises a single integral or unitary one-piece construction formed by 3D printing an elastomeric polymeric material. Basketball 20 has a general spherical shape comprising a pair of opposite polar regions 22-1, 22-2 with a series of surface strips 24-1, 24-2 (collectively referred to as surface strips 24), 26-1, 26-2 (collectively referred to as surface strips 26), 28-1, 28-2 (collectively referred to as surface strips 28) and 30-1, 30-2 (collectively referred to as surface strips 30). Surface strips 24-1, 24-2 converge at and extend between polar center points 32-1 and 32-2 of basketball 20. Surface strips 24-1, 24-2 are coplanar, extending in a plane that that intersects a center point of basketball 20. Surface strips 26-1, 26-2 converge at and extend between polar center points 32-1 and 32-2. Surface strips 26-1, 26-2 are coplanar, extending in a second plane that is perpendicular to the first plane and that intersects a center point of basketball 20. Surface strips 28-1, 28-2 have endpoints offset from polar center points 32-1 and 32-2 and generally bisect portions of the outer circumference of basketball 20 between surface strips 24-1, 24-2 and surface strips 26-1, 26-2.

In the illustrated examples, each of surface strips 24, 26, 28 and 30 additionally comprises a series of perforations 31 that extend completely through such surface strips. Perforations 31 comprise small openings that facilitate powder removal of cycle time during printing of the basketball 20. In the example illustrated, such perforations 31 may have polygonal shapes. In other implementations, such perforations 31 may have other shapes, such as circular shapes. In some implementations, the perforations may have patterns so as to form a graphic or so as to spell out a logo or name.

Although the example illustrated perforations 31 extending substantially along the entirety of each of surface strips 24, 26, 28 and 30, in other implementations, such perforations 31 may be located at the selected portions of selected surface strips 24, 26, 28 and 30. For example, in some implementations, the provision of such perforations may be limited to those surface strips that extend along the equator and prime meridian of basketball 20. Such perforations may be omitted and landings, such as landing 90, wherein a logo or emblem may be provided. In yet other implementations, the provision of perforations 31 may be at other selected locations. In some implementations, perforations 31 may be omitted.

Surface strips 24, 26, 28 and 30 are integrally formed as part of an outer surface of basketball 20. Each of surface strips 24, 26, 28 and 30 resides in a depressed portion or in a recessed portion of the outer circumferential surface of basketball 20. In the example illustrated, each of surface strips 24, 26, 28 and 30 extends between consecutive circumferential regions that aesthetically appear as panels and that are lobular in shape. For purposes of this disclosure, the term “lobular” and “loby” refer to the surface of a region having a smaller radius of curvature as compared to the overall radius of the basketball. In the example illustrated, basketball 20 comprises eight loby circumferential regions or aesthetic panels 36-1, 36-2, 36-3, 36-4, 36-5, 36-6, 36-7, and 36-8 (collectively referred to as panels 36) that mimic the conventional appearance of a regulation or sanctioned competitive play basketball.

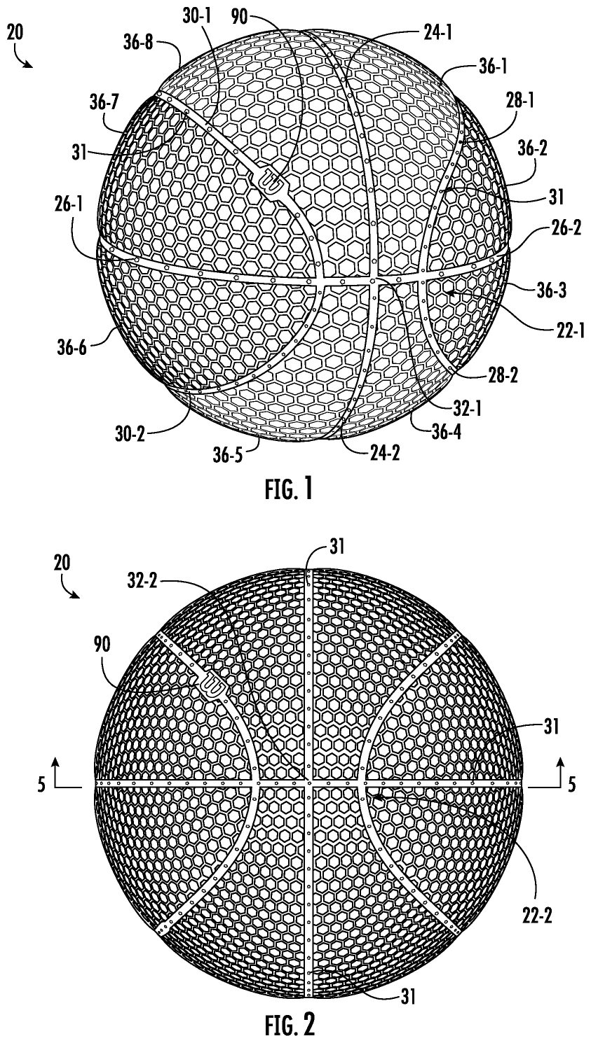

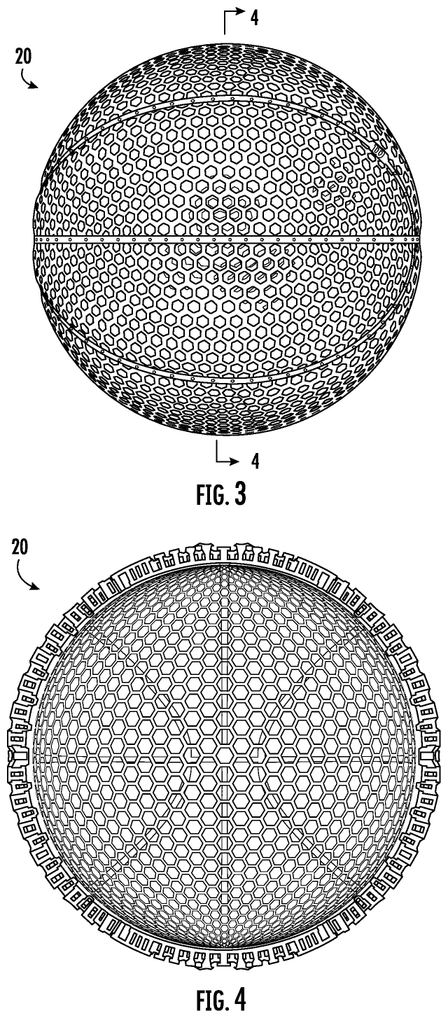

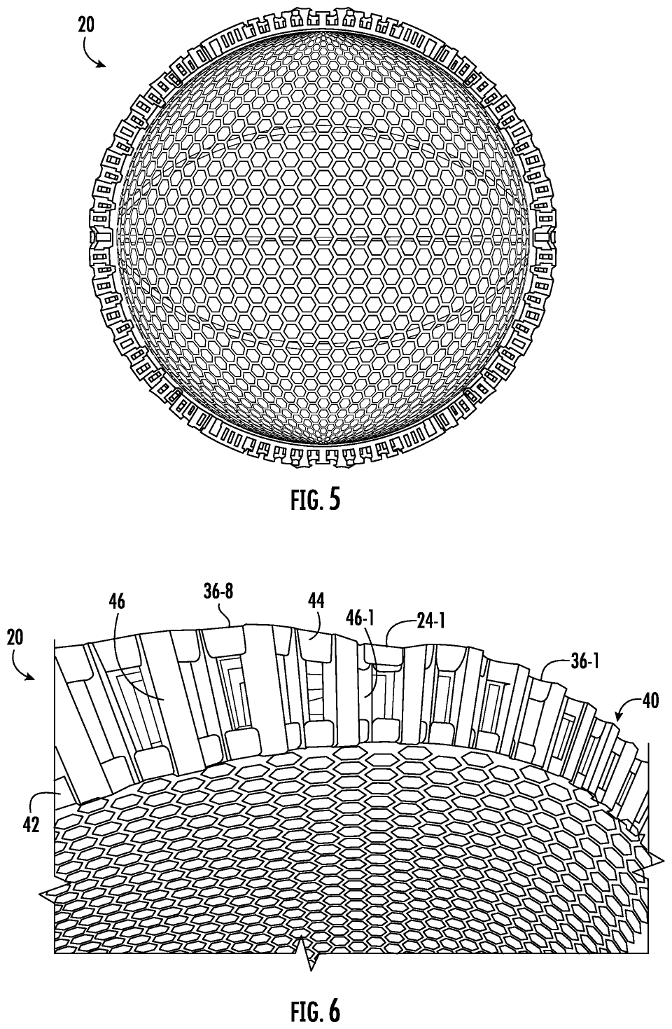

FIGS. 4 and 5 are sectional views of basketball 20 taken along lines 4 and 5 of FIGS. 3 and 2, respectively. FIG. 6 is an enlarged view of a portion of basketball 21 opposite sides of surface strip 24-1. FIG. 7 is an enlarged outer view of a portion of basketball 20 on opposite sides of surface strip 24-1. As shown by FIGS. 6 and 7, basketball 20 comprise a single integral and continuous outer wall 40 that comprises an inner lattice 42, an outer lattice 44 and a radial beams 46.

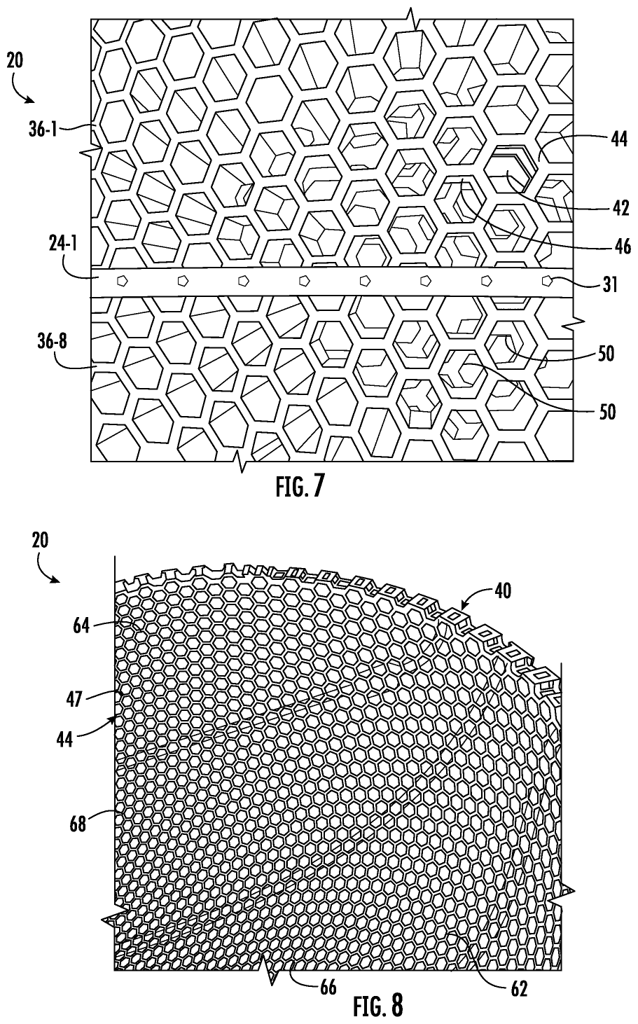

FIG. 8 is a sectional view of basketball 20 from an inside of basketball 20 to illustrate inner lattice 42, wherein a portion 47 of wall 40 is illustrated without the inner lattice 42 and without the radial beams 46 to better illustrate outer lattice 44. Inner lattice 42 forms an inner layer providing an inner surface of wall 40, adjacent to a generally hollow interior of basketball 20.

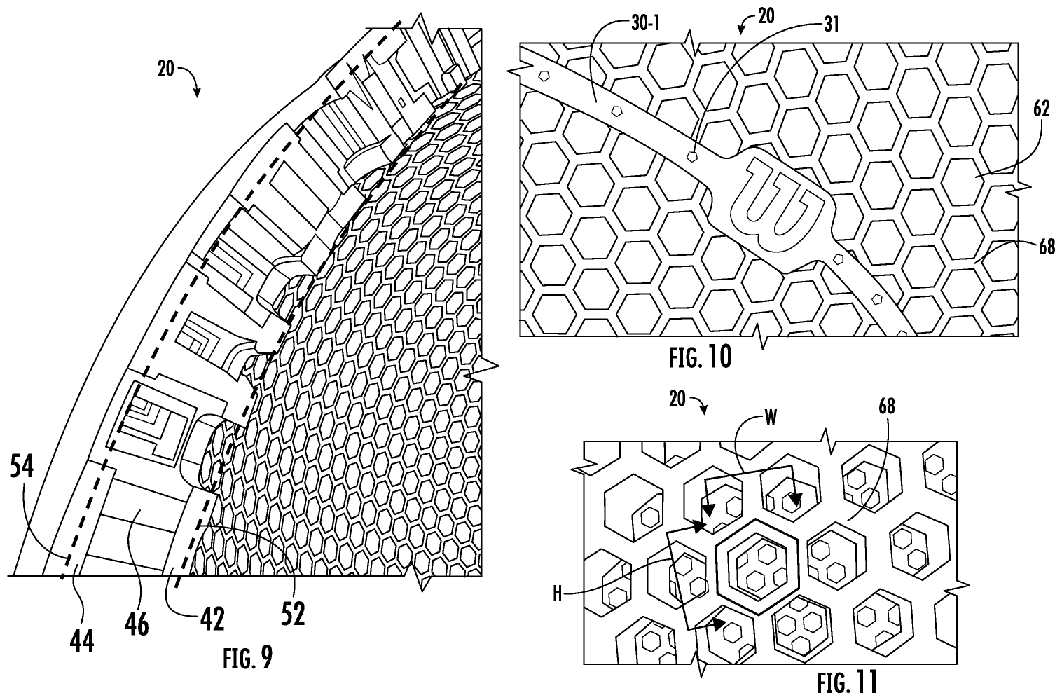

Outer lattice 42 and surface strips 24, 26, 28 and 30 form an outer layer of wall 40, providing an outermost surface of basketball 20. FIG. 9 is an enlarged sectional view of basketball 20 illustrating the general profile of the inner layer 52 formed by inner lattice 42 and the general profile of outer layer 54 formed by outer lattice 44. As discussed above, the outer layer 54 is loby between consecutive surface strips. In contrast, inner layer 52 is circumferential, having the same radius as that of basketball 20.

As shown by FIG. 8, inner lattice 42 comprises a matrix of interconnected hexagonal cells 62. Outer lattice 44 comprises a matrix of interconnected hexagonal cells 64 extending between surface strips 24, 26, 28 and 30. FIGS. 10 and 11 illustrate the example hexagonal cells 62 in more detail. In the example illustrated, cells 62 and 60 are identical in shape and size. Each of cells 62 and 64 has a center-to-center distance of at least 5 mm and no greater than 12 mm. Each of cells 62 and 54 has a hole size of at least 1 mm and no greater than 10 mm. The hole size of cells 64 is sufficiently small such that human adult fingers may not get stuck in the outer lattice 44.

In other implementations, cells 62 and 64 may both be the same, but may have different shapes other than hexagonal shapes. For example, cells 62 and 64 may both have a circular shape, a pentagonal shape, and octagonal shape or the like. In other implementations, cells 62 and 64 may have different shapes, wherein cells 62 have a first shape while cells 64 have a second different shape. In some implementations, cells 62 and 60 sizes. For example, cells 62 may be larger than cells 64 or cells 64 may be larger than cells 62.

Radial beams 46 extend between and interconnect inner layer 52 and outer layer 54. Radial beams 46 extend between inner lattice 42 and outer lattice 44 of panel 36. Radial beams 46 extend between inner lattice 42 and surface strips 24, 26, 28 and 30 of outer layer 54. As shown by FIG. 12, radial beams 46 extend along radial axes that intersect the center point of basketball 20. As further shown by FIG. 12, each of radial beams has a particular radial height RH. The radial height refers to the radial distance between a top of the beam 46 and a center point of the basketball 20. The radial heights RHs may vary amongst different radial beams 46. In the example illustrated, those particular beams 46 that underlie surface strips 24, 26, 28 and 30 have a shorter radial height RH as compared to other radial beams 46 that underlie outer lattice 44. FIG. 6 illustrates a particular radial beam 46-1 that has a shorter radial height RH as compared to other radial beams 46 that underlie outer lattice 44.

As shown by FIG. 13, each of radial beams 46 has a beam length BL. Beam length refers to the radial distance between the top and the bottom of the particular beam 46. Beam length may vary amongst different beams 46. In the example illustrated, those particular beams 46 that underlie surface strips 24, 26, 28 and 30 have a shorter beam length BL as compared to other radial beams 46 that underlie outer lattice 44. Beam 46-1 in FIG. 6 has a shorter beam length BL as compared to other radial beams 46 that underlie outer lattice 44. In some implementations, a particular radial beam 46 may have a shorter radial height, but the same beam length as compared to other radial beams, where the inner lattice 42 has a corresponding smaller radius underlying the particular radial beams 46 that has a shorter radial height. Conversely, in some implementations, particular radial beams 46 may have the same radial height but a shorter beam length where the inner lattice 42 has a corresponding greater radius underlying the particular radial beams 46 that has the shorter beam length.

As shown by FIG. 14, each of radial beams 46 of basketball 20 has a beam thickness BT. The beam thicknesses (or diameters) of individual beam 46 may vary. In the example illustrated, radial beams have a thickness ranging from 0.8 mm to 3.5 mm. Beam thickness may be uniform for a given beam or may be thicker or wider at the center of the beam to provide more stiffness and prevent buckling.

In the example illustrated, those radial beams 46 that underlie surface strips 24, 26, 28 and 30 have a greater thickness as compared to the thickness of those radial beams 46 that underlie portions of outer lattice 44. Such distributions assist in providing a more consistent bounce or rebound performance along different circumferential portions of basketball 20. As will be described hereafter, in some implementations, the beam thicknesses of those radial beams 46 located along the polar regions may have a lesser thickness as compared to those radial beams 46 located between the polar regions.

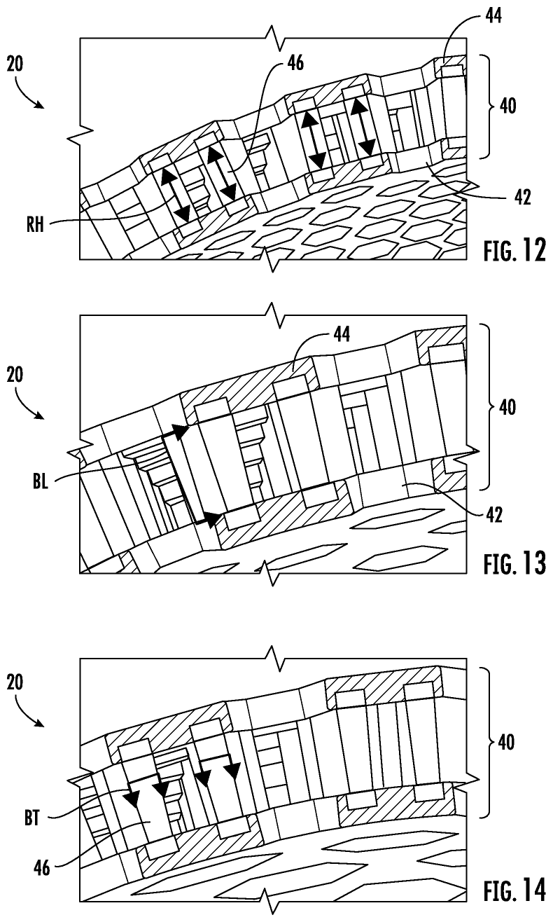

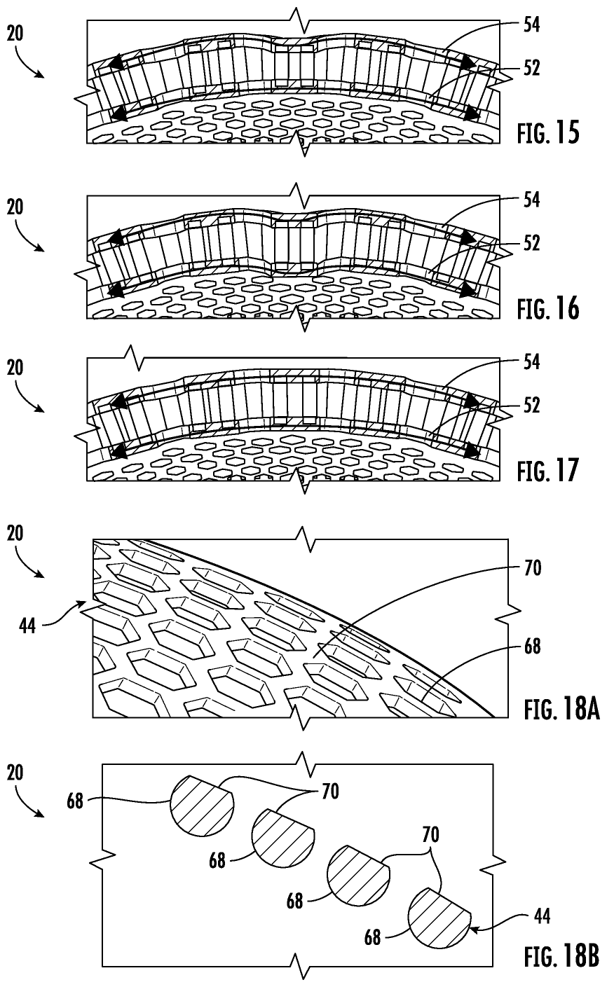

As discussed above, outer layer 54 is lobular in shape. As shown by FIG. 15, inner layer 52 is circumferential or “flat”, lacking any depressions. As shown by FIG. 16, in other implementations, both inner layer 52 and outer layer 54 may be loby, wherein the depressions or recessed portions are circumferentially aligned with one another. In such implementations, the beam length of the radial beams 46 connecting the inner layer 52 and the outer layer 54 would be substantially constant, even in regions where the radial outer surfaces of layers 52 and 54 turn concave. In some implementations, although both layers 52 and 54 are loby, layers 52 and 54 may have different curvature radii. For example, inner layer 52 may have a slight inward depression or curvature between adjacent panels 36 while outer layer 54 has a greater inward depression or curvature between adjacent panels 36.

As shown by FIG. 17, in some implementations, both inner layer 52 and outer layer 54 may have generally circumferential or flat profiles, lacking any depression between panels. In such implementations, panel 36 may not be loby, but may have the same radius of curvature as that of basketball 20. In such implementations, the surface strips may have outer circumferential surfaces that are flush or level with the outer circumferential surfaces of outer lattice 44.

FIGS. 18A and 18B illustrate the outer surface of basketball 20. In the example illustrated, the circumferential beams 66, forming inner lattice 42, have a generally circular or oval cross-sectional shape. In contrast, as shown by FIG. 18B, the circumferential beams 68 forming outer lattice 44 have outer portions 70 that are cut or flat. As shown by FIG. 18A, this provides a smooth or flat outer surface for panels 36.

FIG. 19 illustrates portions of an alternative outer lattice 144 for an example basketball 120. Basketball 120 is similar to basketball 20 described above except the basketball 120 comprises outer lattice 144. Outer lattice 144 is similar to outer lattice 44 in all respects except that outer lattice 144 comprises circumferential beams 168 which are not flat, but which are rounded. As a result, the tops 170 of beams 168 have a curved or rounded profile to provide a different grip for basketball 120. In some implementations, all of such beams 168 are rounded. In some implementations, selected circumferential beams 168 at selected circumferential portions of basketball 120 are rounded.

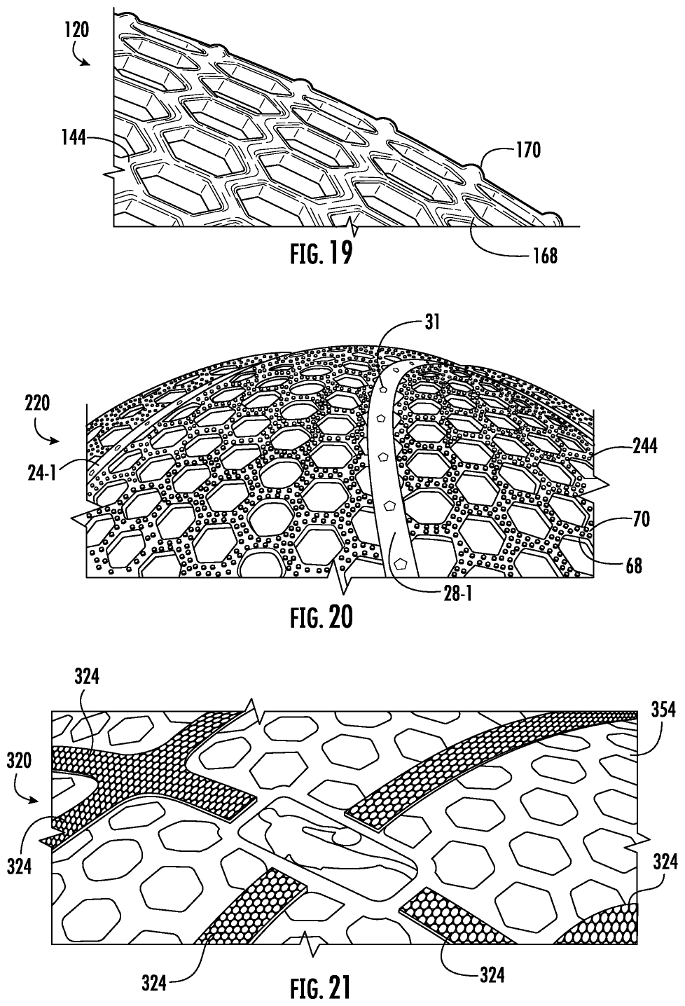

FIG. 20 illustrates portions of an alternative outer lattice 244 for an example basketball 220. Basketball 220 is similar to basketball 20 described above except the basketball 220 comprises outer lattice 244. Outer lattice 244 is similar to outer lattice 44 in all respects except that the flat upper surfaces 70 of circumferential beams 68 are textured rather than being smooth. In the particular example illustrated, the flat tops 70 of circumferential beams 68 are provided with a pebble-like textured surface to enhance grip. In the example illustrated, surface strips 24, 26, 28 and 30 remain smooth and are not textured. In some implementations, all or some of surface strips 24, 26, 28 and 30 may include the same texture as that of top 70 of circumferential beams 68 or may be provided with a different distinct texture. In some implementations, different portions of each of surface strips 24, 26, 28 and 30 may be differently textured.

FIG. 21 illustrates portions of an alternative outer layer 354 of an example basketball 320. Basketball 320 is similar to basketball 20 described above except that basketball 320 comprises outer layer 354. The outer layer 354 is similar to outer layer 54 described above except that outer layer 354 comprises surface strips 324 corresponding to surface strips 24, 26, 28 and 30, but wherein the surface strips have outer surfaces that are textured. In the example illustrated, the outer surfaces of such surface strips 324 are provided with a pebbled or cobblestone texture. In other implementations, the outer surfaces of such surface strips may have other textures. In some implementations, all or some of surface strips 324 may be provided with a different textures. In some implementations, different portions of each of surface strips 324 may be differently textured.

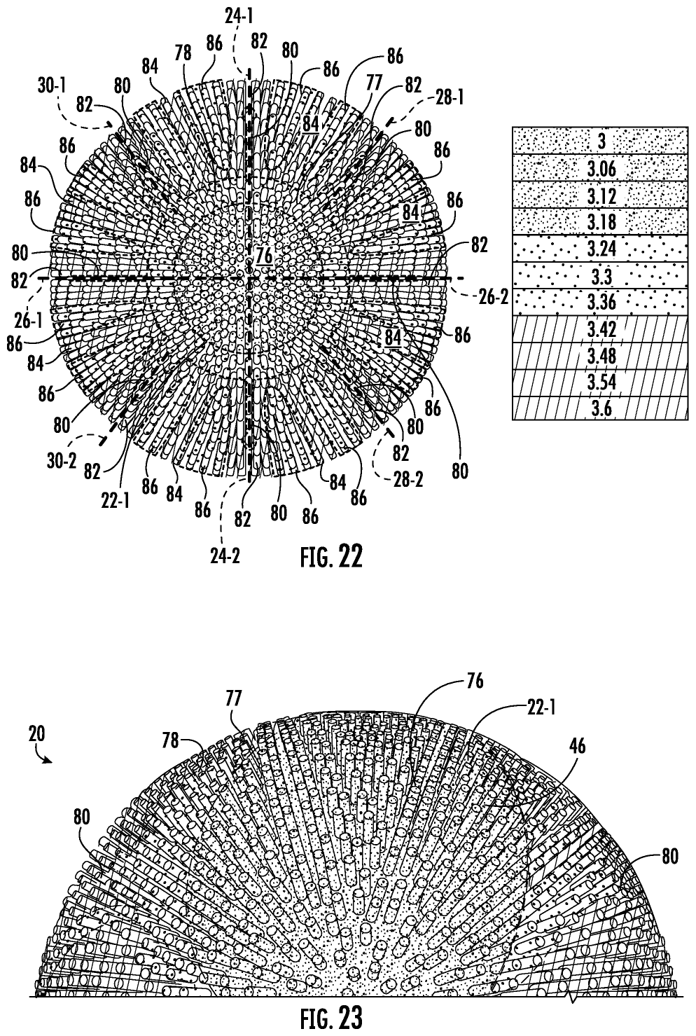

FIGS. 22-25 illustrate an example of basketball 20, wherein the radial beams 46 are provided with a varying radial beam diameter or thickness, wherein different radial beams in different circumferential portions of basketball 20 have different beam diameters or thicknesses. FIGS. 22-25 are heat maps, wherein the different colors correspond to different beam thicknesses/diameter as measured in millimeters. FIG. 23 illustrates basketball 20 without outer layer 54.

The location of surface strips 24, 26, 28 and 30 are indicated in FIGS. 22, 24 and 25 by broken lines. As shown by FIG. 22, at opposite pole regions 22-1 and 22-2, the regions where the surface strips 24, 26, 28 and 30 converge, the radial beams 46 (the polar cap beams 76) have a lesser thickness/diameter than the radial beams at other locations about basketball 20. The polar cap beams 76 form a generally uniform circular region wherein the polar cap beams 76 have substantially the same reduced thickness.

Because the surface strips 24, 26, 28, 30 have a solid density of polymeric material, such surface strips tend to increase the rebound height when the basketballs bounced off of such surface strips. Because the surface strips 24, 26, 28 and 30 converge at pole regions 22, strips 24, 26, 28 and 30 are closest at the pole regions 22 and have the greatest surface concentration. But for the reduced thickness or diameter of polar cap radial beams 76, the high concentration of the solid surface strips 24, 26, 28 and 30 might otherwise increase the rebound or bounce height of the basketball when bounced off of the pole regions 22. The reduced thickness of the polar cap beams 76 at the pole regions 22 tends to reduce rebound height. The reduced thickness of the polar cap beams 76 at the pole regions 22 reduces bounce to neutralize or offset any bounce increase caused by the greater concentration (surface area density) of the converging surface strips. The reduced thickness or diameter of the polar cap beams 76 at the pole regions 22-1, 22-2 facilitate a more uniform rebound or bounce. In other words, basketball 20 bounces approximately the same whether the basketball 20 bounces off of the pole regions or other portions of the basketball 20.

Those radial beams 46 that are located along a circumferential perimeter of polar regions 22 and that form ring 77 (as seen in FIG. 2) around the polar cap beams 76 (polar ring beams 78) have a reduced diameter or thickness. The polar ring beams 78 have a thickness that is less than the thickness of the polar cap beams 76 due to the lesser concentration of surface strips 24, 26, 28 and 30 further away from the converging points of the surface strips but still less than those radial beams 46 located at other portions of basketball 20. The reduced thickness of the polar ring beams 78 reduce or neutralize the enhanced bounce that otherwise might exist at the edges of the regions 22 due to the convergence and concentration of the surface strips. The reduced thickness of the polar ring beams 78 facilitates more consistent uniform bounce across different regions of basketball 20.

Similarly, those radial beams 46 that directly underlie those portions of surface strips 24, 26, 28 and 30 that extend from ring 77 in the shape of fingers outwardly projecting from the ring 77 (polar flare beams 80) also have a reduced diameter or thickness. In the example illustrated, the polar flare beams 78 have a diameter or thickness similar to the diameter thickness of polar ring beams 78. The reduced thickness or diameter of the polar flare beams 80 neutralizes the additional bounce that might otherwise occur along the surface strips proximate to where the surface strips converge at the polls. The reduced thickness of the polar flare beams 78 facilitates more consistent uniform bounce across different regions of basketball 20.

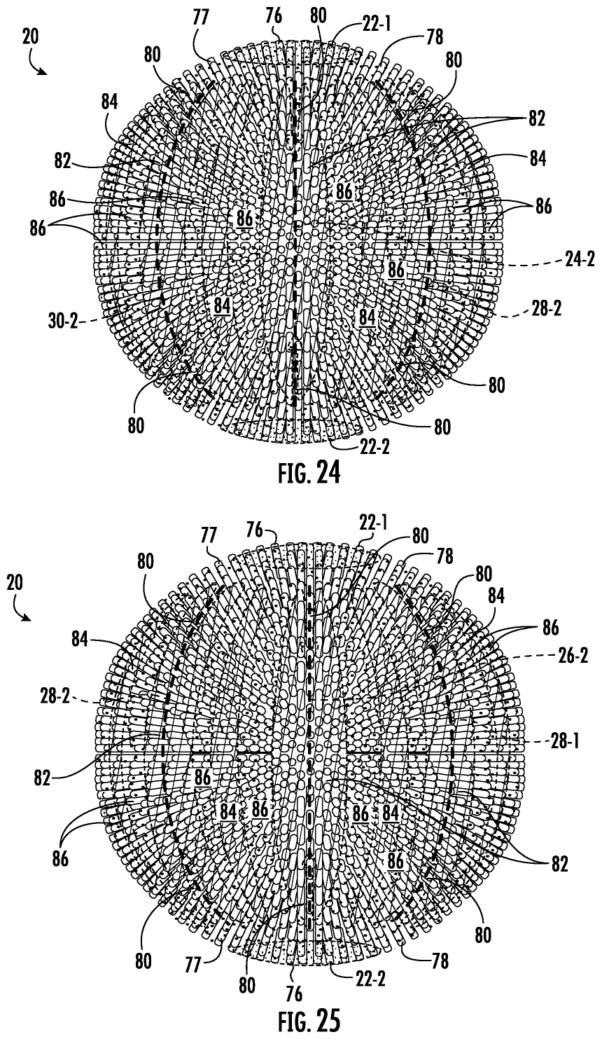

As shown by FIGS. 24 and 25, the thickness or diameter of the radial beams 46 also varies based upon its proximity or relationship to the intermediate portions of surface strips 24, 26, 28 and 30 that extend between the pole regions 22. In the example illustrated, those radial beams 46 between the pole regions 22 (other than the polar flare beams 80) have three general thicknesses. Those radial beams 46 directly underlying or in close proximity to the sides of surface strips 24, 26, 28 and 30 (surface strip beams 82) have a first thickness or diameter that is greater than the thickness or diameter of the polar cap beams 76 at the pole regions 22. The greater thickness or diameter of the surface strip beams 78 accounts for the shorter height and shorter beam length of such surface strip beams 82 (providing the loby shape).

Those radial beams 46 that are equidistantly circumferentially spaced between the surface strips (middle region beams 84) are the farthest from both of the surface strips. To enhance the rebound or bounce of such beams in such regions, the middle region beams 84 are provided with a greater thickness as compared to the thickness of the polar ring beams 78 and a thickness slightly less than the thickness of the surface strip beams 82.

Those radial beams 46 that extend between the surface strip beams 82 and the middle region beams 84 (the spacer beams 86) have a thickness less than the thickness of surface strip beams 82 and middle region beams 84. Spacer beams 86 have a thickness or diameter substantially equal to or slightly greater than the thickness of the polar ring beams 78. The thickness of spacer beams 86 distributes, spreads or evens out any increase in bounce that may occur at locations where the surface strip beams 78 and the middle region beams 80 are located.

Overall, the above-described distribution or variation of different radial beam thicknesses/diameters solves rebound or bounce irregularities that might otherwise exist due to the presence and layout of the surface strips 24, 26, 28 and 30. In implementations where basketball 20 is provided with a different layout of surface strips or where the surface is not loby, the above-described layout or pattern of thickness variations may likewise be different. For example, in non-loby basketballs, basketballs having a constant outer diameter, the thickness of the radial beams underlying the surface strips need not be increased to accommodate a decrease in beam length. In basketballs where the surface strips converge at regions other than the poles of the basketball, the location of those beams 46 having a reduced thickness may likewise shift to the locations where the surface strips converge. The provision of radial beams 46 having different diameters or thicknesses in different regions of the basketball may be omitted where surface strips are also omitted.

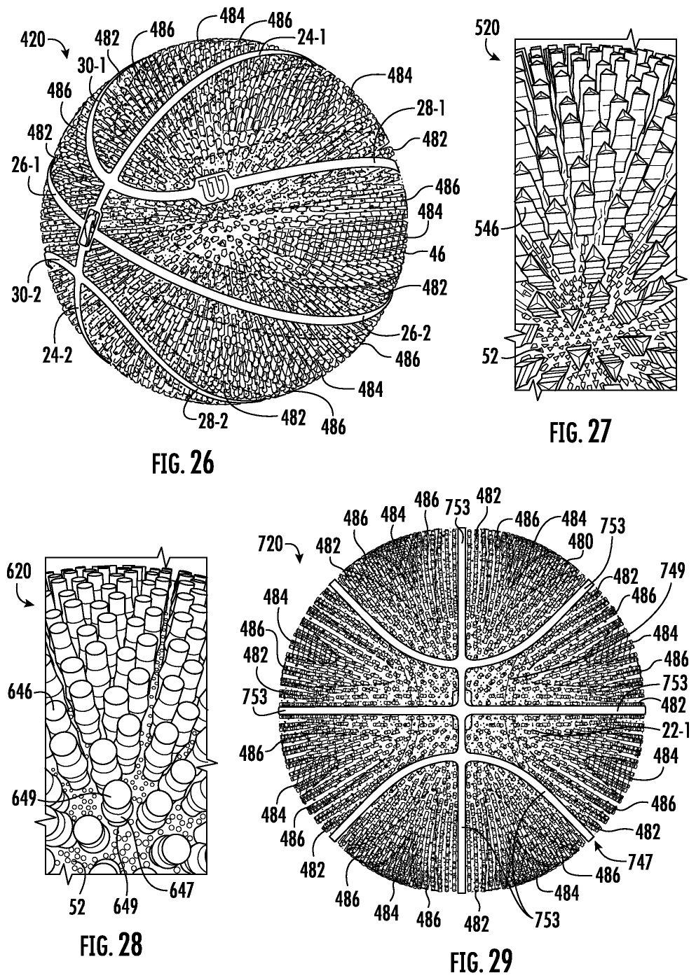

FIG. 26 illustrates portions of an example basketball 420. FIG. 26 illustrates just the radial beams 46 and surface strips 24, 26, 28 and 30, omitting inner lattice 42 and outer lattice 44. The radial beams 46 are further colored to provide a heat map indicating their different diameters or thicknesses. FIG. 26 illustrates another example of how the diameters or thicknesses of the radial beams may be varied and are patterned to provide a more uniform and consistent bounce when the basketball bounces off different portions of its circumference. Basketball 420 comprises the same surface strips 2426, 28 and 30 as basketball 20. Like basketball 20, basketball 420 comprises the above-described inner layer 52 and an outer layer similar to outer layer 54 but being non-loby. The radial beams 46 have a different pattern of radial beam thicknesses. In the example illustrated, those radial beams 46 extending along the surface strips (surface strip beams 482) have a reduced thickness. Those radial beams circumferentially and centrally located between the surface strips (middle region beams 484) have an increased thickness, a thickness greater than that of surface strip beams 482. Those radial beams that extend between the surface strip beams 482 and the middle region beams 484 (spacer beams 486) have a thickness greater than that of surface strip beams 482, but less than that of middle region beams 484.

FIG. 27 is an enlarged view of a portion of a basketball 520, with outer layer 54 omitted. Basketball 520 is similar to basketball 20 except that basketball 520 comprises radial beams 546 in place of radial beams 46. Radial beams 546 each have varying thicknesses along their length and have non-circular cross-sectional shapes. In the example illustrated, beams 546 have triangular cross-sectional shapes. The varying beam thickness profiles in the alternative shapes may be used to vary axial stiffness and thereby vary or control rebound characteristics for the region of the basketball 520 including such radial beams 546.

FIG. 28 is an enlarged view of a portion of a basketball 620, with outer layer 54 omitted. Basketball 620 is similar to basketball 20 except that Best Basketball 620 comprises radial beams 646 in place of radial beams 46. Radial beams 646 have circular cross-sections but have nonuniform thicknesses along their beam lengths. In the example illustrated, each of radial beams 646 has a middle or central portion 647 having a first diameter or thickness and opposite end portions 649 having a second smaller diameter or thickness. In some implementations, the location of the central portion 647 relative to the end portions may be moved up or down, towards inner layer 52 or outer layer 54 to vary or control rebound performance. Likewise, the thickness or diameter of the central portion 647 and/or the end portions 649 may be varied to vary and control rebound performance.

FIG. 29 illustrates portions of an example basketball 720.

Basketball 720 is similar to basketball 420 except that basketball 720 various a density of radial beams 46 and additionally comprises an internal skeleton 747. In contrast to basketball 420, outer layer 54 is loby. FIG. 29 omits inner and outer layer 54 for purposes of illustration. FIG. 29 omits surface strips 24, 26, 28 and 30 for purposes of illustration. As with basketball 420 in FIG. 26, the radial beams 46 are further colored to provide a heat map indicating their different diameters or thicknesses.

In the two opposite pole regions 22-1 and 22-2 (not shown), basketball 720 has a lower density of radial beams 46. The lower density of radial beams 46 reduces, offsets or neutralizes any extra rebound or bounce that may occur due to the increased concentration of surface strips 24, 26, 28 and 32, as well as the higher concentration of portions of skeleton 747. The density of radial beams 46 increases outside of closure 749 formed by the converging portions of skeleton 747. The density of radial beams 46 is reduced in those regions adjacent to or underlying those portions of surface strips 24, 26, 28 and 30 that are in close proximity to closure 749.

Inner skeleton 747 is provided by added reinforcing channels 753 on the outer wall of the inner lattice 42. The reinforcing channels 753 provide additional rebound performance in such regions. Although the reinforcing channels 753 converge to form closure 759, the additional rebound at such pole regions 22-1, 22-2 is offset by the lower density of radial beams 46 and their reduced thicknesses.

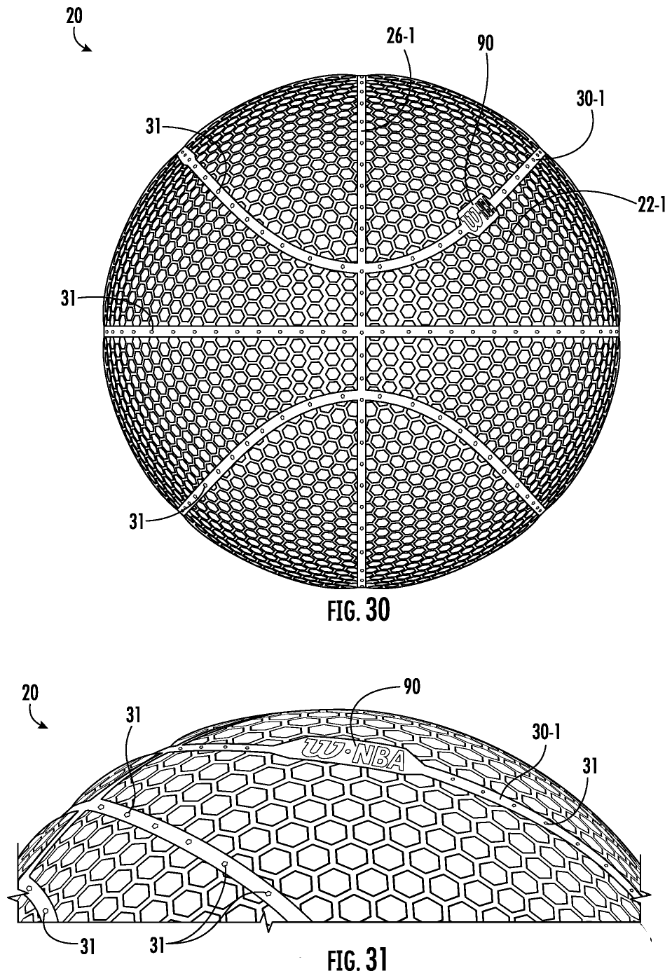

FIGS. 30-39 illustrate various examples of how any of the above-described basketballs may be provided with branding, logos or other information (customized information, manufacture date, style or version data, patent data, advertising or the like) at different locations (hereinafter referred to as an “information landing”, a “landing” or “landings”). FIGS. 30-39 illustrate various examples of how such information may be presented and located so as to have a reduced impact upon the feel and rebound performance/consistency of the basketball. FIGS. 30-39 illustrate various information locations on a single basketball 20. As should be appreciated, basketball 20 may omit all or at least some of the particular information landings.

FIGS. 30 and 31 illustrate information landing 90. Information landing 90 is located or formed along surface strip 30-1 and is wider than those portions of surface strip 30-1 which extend from opposite ends of information landing 90. Information landing is located nearer within polar region 22-1, proximate to where surface strip 30-1 connects to surface strip 26-1. In the example illustrated, landing 90 has embossed thereon logo information comprising “W” and “NBA”. In other implementations, other information may be branded on landing 90, such as shown in FIGS. 1 and 2. In yet other implementations, the information may be provided are formed upon landing 90 in other fashions. For example, the information may be placed upon landing 90 by printing, stamping or molding. The recessed nature of such embossing lessons any rebound impact.

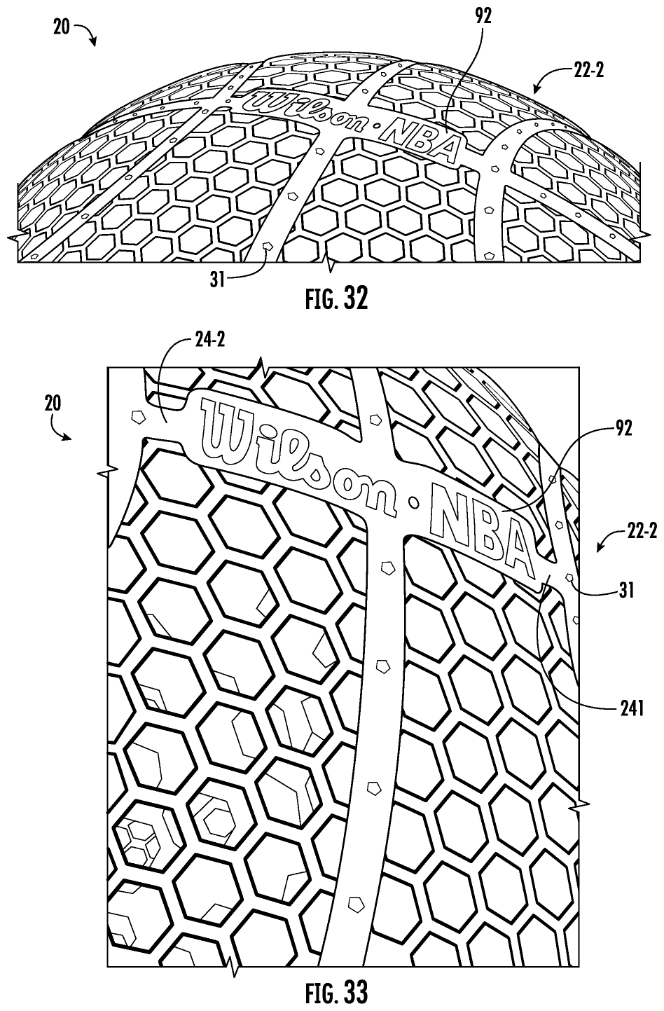

FIGS. 32 and 33 illustrate an example landing 92. Landing 92 is formed at the center of pole region 22-2 of basketball 20. Landing 92 is formed along a conjunction of surface strips 24-1 and 24-2. Landing 92 has a width greater than the width of surface strips 24-1 and 24- and is recessed along with surface strips 24-1 and 24-2 (due to the loby shape). In other implementations, landing 92 may be formed at pole region 22-1. In other implementations, landing 92 may be formed at a conjunction of surface strips 26-1 and 26-2 at home region 22-2 or at pole region 22-1. As with landing 90, landing 92 has embossed thereon logo information comprising “Wilson” and “NBA”. In other implementations, information may be provided on landing 92 in other fashions such as by printing, stamping or molding.

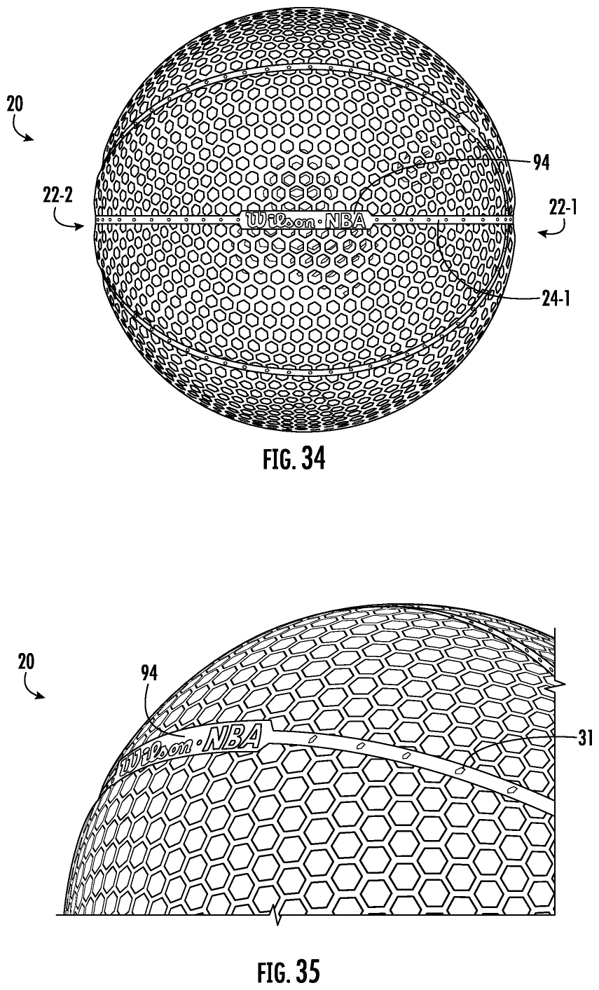

FIGS. 34 and 35 illustrate an example landing 94. Landing 94 is formed at a center point of surface strip 24-1, centered between the centers of pole regions 22-1 and 22-2. Landing 94 has a width greater than the width of surface strip 24-1 and is recessed along with surface strip 24-1 (due to the loby shape). In other implementations, landing 94 may alternatively be formed along at center points between the pole regions 22-1 and 22-2 along any of the surface strips 24, 26, 28 and 30. Like the other landings, landing 94 has embossed thereon logo information comprising “Wilson,” the Jerry West NBA logo, and “NBA”. In other implementations, information may be provided on landing 92 in other fashions such as by coating, printing, stamping or molding.

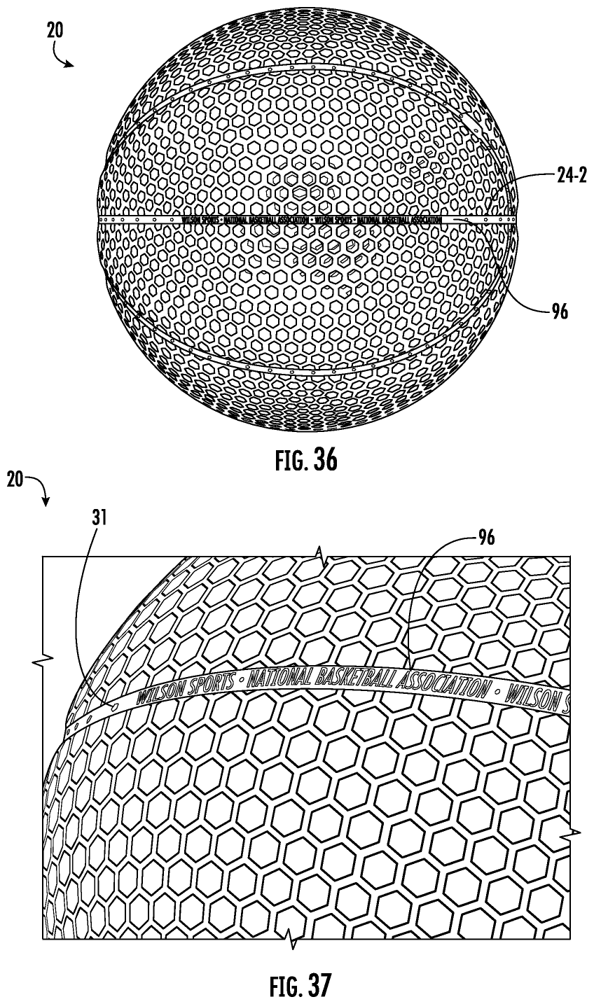

FIGS. 36 and 37 illustrate an example landing 96 of basketball 20. Landing 96 is formed as part of a central portion of surface strip 24-2. Landing 96 does not alter the width of surface strip 24-2. In the example illustrated, landing 96 includes information that projects from the outer surface of surface strip 24-2. The height of the raised portions providing the information is less than the extent to which the outer surface of surface strip 24-2 is recessed. Because landing 96 does not alter the width of surface strip 24-2 and because the raised data portions have a height less than an extent to which surface strip 24-2 is recessed, the provision of landing 96 and his information has a lower impact upon any rebound or bounce variation that might otherwise result from its presence. As should be appreciated, landing 96 may be formed on any of the surface strips a central point along such surface strips between the polar regions 22 or at other locations along the surface strips.

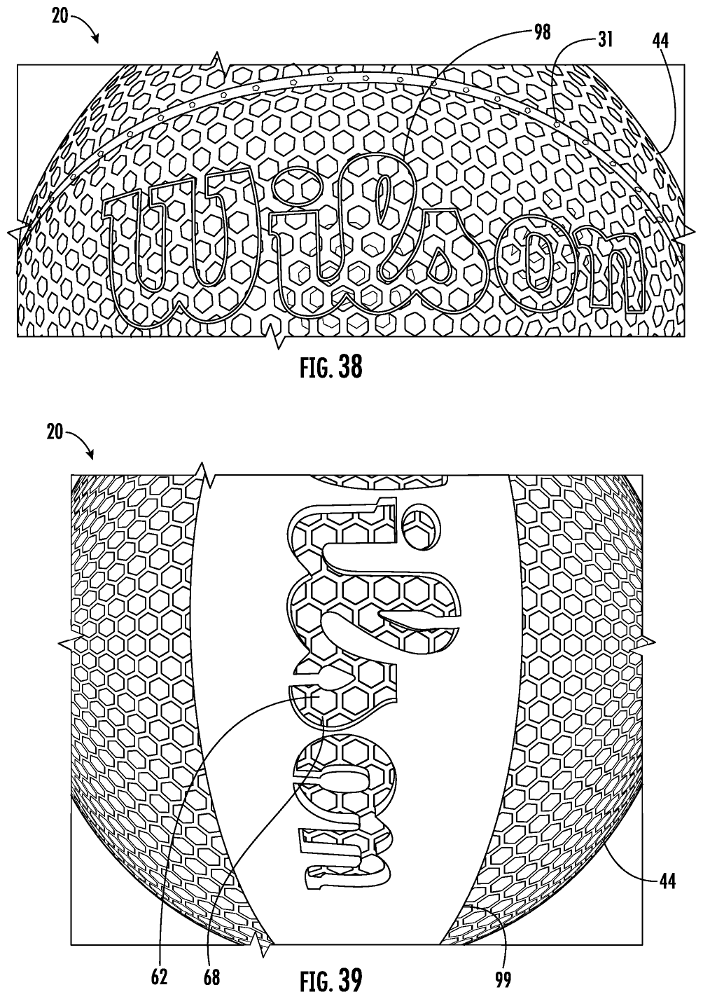

FIG. 38 illustrates a portion of basketball 20 provided with external information 98. FIG. 38 illustrates an example of how information may be integrated and outer lattice each of the above-described 3D printed basketballs. In the example illustrated, the information is in the form of an example logo “Wilson”. The logo is formed by 3D printing a line of material over and across voids of the cells of the outer lattice. The example presents information in a subtle fashion and is thus likely to have a large impact on the rebound performance of basketball 20 due to the inclusion of the example logo.

FIG. 39 illustrates a portion of basketball 20 provided with external information coating 99. Information coating 99 is applied with a post process application. For example, information coating 99 may be coated, painted or otherwise formed on the exterior of outer lattice 44 of basketball 20. In the example illustrated, the coating may cover and span across the open cells of outer lattice 44. In the example illustrated, information coating 99 is presented in the shape of a panel. The panel may be provided with various customized colors and other ornamentation.

In some implementations, what is shown in FIG. 39 may be in the form of a mask 99 which is positioned over or more removably applied to the outer surface of basketball 20. In such an implementation, a paint or other durable coating may be sprayed or otherwise applied across the mask 99, through which openings, forming a patterned coating on outer lattice 44. Depending upon factors such as the viscosity of the coating and the amount of coating, the coating applied through the openings in the mask 99 may cover the openings or voids of the individual cells of outer lattice 44 or may alternatively cover the outer surfaces of the outer circumferential beams 68 while leaving intact the openings or voids of the individual cells 62.

FIG. 40 illustrates one example process or method for forming a 3D printed basketball, such as basketball 20. In one implementation, basketball 20 is formed from an additive printing process such as a selective laser sintering or multi-jet fusion. With selective laser sintering and multi-jet fusion, basketball 20 is formed or built in a layer-by-layer fashion in the z direction (the vertical direction) resulting in multiple x-y plane layers. With selective laser sintering and multi-jet fusion, bed 900 is provided with a polymeric powder capable of being sintered (fused or melted).

With selective laser sintering (SLS), a laser is selectively applied to the powder to selectively heat and sinter/melt portions of the powder to form a particular x-y plane layer. The selective application the layer may involve a computer program which controls the x-y (horizontal) positioning of a laser and which controls lowering of the bed, all based upon a sintering pattern or architecture corresponding to the different structures and features of basketball 20 and embodied as code in a non-transitory computerized readable medium. The bed may be lowered and a new layer of fresh powder formed overtop the previously formed x-y plane layer. After the two-dimensional layer of sintered or fused material is made, the platform or floor 902 advances (is lowered) and a new layer of powder is swept over the prior completed layer. The laser is once again selectively applied to selectively heat and fuse/melt/sinter selected portions of the fresh powder to form the next x-y plane layer, potentially stacked upon the prior x-y plane layer, to form a 3D shape. This process continues until basketball 20 is completed.

Multi-jet fusion (MJF) printing is similar to selective laser sintering except that an absorptive die is printed, such as through inkjet printing, on the powder to form a sinter pattern for a particular x-y plane of the basketball being formed. The dye, when activated with a laser or other radiation, causes the powder to melt and fuse/sinter. The printed sinter pattern of dye defines where powder is fused/melted/sintered upon being activated by a potentially less selective laser or application of a wide band of powder sintering heat or radiation. The selective application of the dye may involve a computer program which controls the x-y (horizontal) positioning of a printer or its printhead(s), such as an inkjet printer, and which controls lowering of the powder bed, all based upon a sintering pattern or architecture corresponding to the different structures and features of basketball 20 and embodied as code in a non-transitory computerized readable medium. As with selective laser sintering, the layer-by-layer process is repeated, wherein the sequentially formed layers of sintered powder form basketball 20.

As shown by FIG. 40, basketball 20 may be formed in a layer-by-layer fashion using SLS or MJF in the example powder bed 900. The panel or floor 902 of powder bed 900 may be sequentially lowered along the z-axis during the formation of each of the layers of basketball 20. As discussed above, a laser may be selectively positioned or a sinter activating pattern of “a dye” may be selectively applied to the fresh powder of each layer to form the features of basketball 20.

Material properties of different portions or regions of basketball 20 may vary depending upon the orientation at which basketball 20 is printed in bed 900. Because basketball 20 may be printed in a layer-by-layer method using SLS or MJF properties of basketball 20 may have stronger/stiffer/higher elongation in the horizontal or x-y plane and be weaker in the z axis or vertical direction. As shown by FIG. 40, the additive printing of basketball 20 is performed such that the centers of the regions 22-1 and 22-2 are aligned in the x-y plane (any rotation about the z-axis). Said another way, with basketball 20, the additive or 3D printing of basketball 20 using SLS or MJF is performed such that the center point of polar regions 22-1 and 22-2 are formed in the same x-y plane or layer of sintered/fused powder. The center point of the polar regions 22 may be maintained in the same x-y plane or layer of fused powder with any rotation about the X axis. The particular orientation of the basketball 20 being formed within bed 900 may be defined by the particular programming, instructions or code contained in the non-transitory computerized readable medium which directs the lowering of floor 902 as well as the selective application of a laser beam or the selective application of the dye during the layer-by-layer printing process. Because basketball 20 is printed with the center point of the polar regions 22-1, 22-2 aligned in the x-y plane during printing, basketball 20 may have a more consistent shape and rebound along its various circumferential regions as compared to orienting or centering the center points of pole regions 22-1, 22-2 along the z-axis. Printing with the polls on the sides achieves more uniform material properties, increases overall rebound and reduces dead spot.

Because the 3D printed material may be stiffer at the top and bottom of the basketball 20 as compared to the sides of basketball 20 due to layer-by-layer deposition (stiffer may equate to higher rebound), in some implementations, those radial beams 46 proximate to a top and bottom of basketball 20 (as seen in FIG. 40) may be provided with a thickness that is relatively less than the corresponding thickness of the beams along the sides of the basketball (as seen in FIG. 40) to provide more uniform rebound. The radial beams not reinforced by surface strips (also referred to as reinforcing channels) may also be stiffened with increased stiffness as shown in FIG. 40.

In addition to rebound, the shape of the basketball may also be influenced by the layer-by-layer 3D printing process. The size of basketball may impact the player's ability to the ball and perform maneuvers during play. Successively formed layers that make up the basketball may result in dimensions of the basketball varying which affect both grip performance as well as rebound and role characteristics. To address such variations, the X-Y-Z scale factors are adjusted for such layer-by-layer 3D printing in a manner specific to each additive powder method, ball geometry, material and such or machine and may be tuned.

Material properties of basketball 20 may be sensitive to how basketball 20 is printed. Typical data sheets regarding materials report material properties as injection molded values. However, material properties vary greatly based on: (1) print method, e.g., selective laser sintering (SLS) or multi-jet fusion (MJF), (2) depending on print geometry due to skinning effects, and (3) print orientation, as both SLS and MJF are built layer-by layer in z direction, resulting in multiple x-y plane layers. In

In some implementations, basketball 20 (or any of the other above-described 3D printed basketballs) may be formed from a polymer having the following properties (measured as injection molded):

| | | Value, | Value, | Notes |
|---|---|---|---|---|
| Material | Units | Current | Acceptable | Why |
| Property | Test Method | embodiment | Range | Important |
| Density | g/m³ | 1.01 | 0.9-1.2 | Mass target |
| Durometer | Shore A | 90-92 | 80-92 | Hand feel |
| Flexural | MPa | 90 | 80+ | Rebound |
| modulus | | | | |
| Tensile | MPa | 80 | 50+ | Rebound, |
| modulus | | | | durability |
| Ultimate | MPa | 40 | 30+ | Durability |
| tensile | | | | |
| Elongation | % | 550 | 150+ | Durability |
| Rebound | %, ASTM | 58 | 50+ | Rebound |
| resilence | D7121/DIN53512 | | | |
| | DIN53516 | | | |

In some implementations, any of the above-described 3D printed basketballs may be 3D printed from a thermoplastic polymer. In some implementations, any of the above-described 3D printed basketballs may be formed from a polyether block amide or PEBA thermoplastic elastomer such as PEBAX (Registered Trademark) 4533 commercially available from Arkema imprinted on EOS branded or DTM/ISI (Non-EOS branded equipment) printers. In some implementations, any of the above-described 3D printed basketballs may be 3D printed from an Evonik thermoplastic polyamide (a chemical copolymer of a thermoplastic elastomer and a highly flexible nylon) (grades; racial soft to hard segment).

In some implementations, any of the above-described 3D printed basketballs may be 3D printed from an Evonik thermoplastic copolyester, Infinam 8008P printed on Hewlett-Packard or other powder-based printers. In some implementations, any of the above describe 3D printed basketballs may be 3D printed from a material such as PA12. From a rigidity/energy return standpoint, PA12 has value of 1.5-2.5 GPa young's modulus, but elongation to break is only ˜10%, which may be especially beneficial given the high frequency at which the basketball is to be bounced or dribbled. Higher elongation is important because the material undergoes high strain rate deformation to relatively high strains, with repeated cycles with limited recovery time between impacts. If the elongation to break is 100% for example, an event may cause a strain of 20% within 10 ms.

Basketball 20, formed from the above materials and having the above-described configuration has a size and performance characteristics equivalent or similar to that of officially sanctioned competitive play basketballs, such as competitive play basketballs sanctioned by the NBA, NCAA and NFHS (National Federation of High Schools). For example, when dropped from a height of 72″ measured from the bottom of the ball, minimum rebound for a retail ball is 49″ (measured from top of ball) and for an NBA game ball it is 52.″ The maximum rebound for an NBA ball is 56 inches. Basketball 20 may have a rebound of at least 52 inches and slightly above 54 inches when dropped from a height of 72 inches. Basketball 20 further has a reduced “dead spot” (max rebound-min rebound across different locations on the ball) of under 2″, comparable to NBA sanctioned competitive play basketballs).

In some implementations, basketball 20 formed according to the above-described parameters, has the following characteristics relative to an NBA sanctioned competitive play basketball.

| | | NBA | 3D Printed | |
|---|---|---|---|---|
| | Detail | Game ball | Basketball | Note |
| Specifications | Circumference(mm) | 749-759 | 742-754 | (Circumference) |
| | Mass(g) | 567-602 | 599-628 | Intentionally small to |
| | Rebound (in) | 52-56 | 52-53 | improve single-hand grip for |
| | OOR (mm) | <3 | <3 | dunk. Can be modified as |
| | Wobble Test | L2 - R2 | L2 - R2 | needed. |
| | Abrasion Loss (g) | 9/32 | 25 | (Mass) Intentionally higher, |
| | Testing Cycles (K) | 25 | 25 | responding to player |
| | Testing Plate | Wood | Concrete | prototype test feedback |
| | Inflating Instruction | 8 | | (Rebound) 48-50″ = 5-6 psi |
| | on valve (psi) | | | (OOR) Most ball are now <3 |
| | | | | with some outliers |
| Other | Blunt impact | OK | OK | |
| | (baseball bat) | | | |
| | Durability - Scottie | 100 | Acceptable | Uneven bounce > 50K |
| | Piston (K) | | | |
| | Durability - Shooting | 10 | Acceptable | Uneven bound after 10K |
| | machine (K) | | | |
| | Dead spot (in) | <1 | <4 | Still improving |

The open celled exterior of the above-described basketballs, due to the open cells of outer lattice 44 and inner lattice 42, may result in aerodynamic resistance which may impact the passing of the basketball and the flight of the basketball during a shot. In other words, the basketball is hollow and generally perforate with air flow passages from the exterior of the basketball communicating with the hollow interior and the center point of the basketball. The air flow passages also continuously extend through the basketballs from one outer side to another outer side of the basketballs. In some implementations, any of the above describe 3D printed basketballs may be additionally provided with a skin which covers, blocks, or occludes the cell openings of the inner lattice 42 and/or the outer lattice 44. In some implementations, the skin may be translucent or transparent to maintain the ability to view the unique and aesthetically pleasing pattern of at least outer lattice 44. To reduce any breaks or seams, and assembly complexity, the skin may comprise a one-piece skin having a single pair of opposing edges, a single opening or no openings or edges. In some implementations, the skin may serve as a bladder having an interior that may be inflated. In other implementations, the skin may have an interior that is exposed to atmosphere, wherein the interior is not inflated and is at atmospheric pressure. The resilient nature of wall 40 facilitates basketball 20 having an interior that may be at pressure, eliminating the need to monitor or maintain inflation of the basketball.

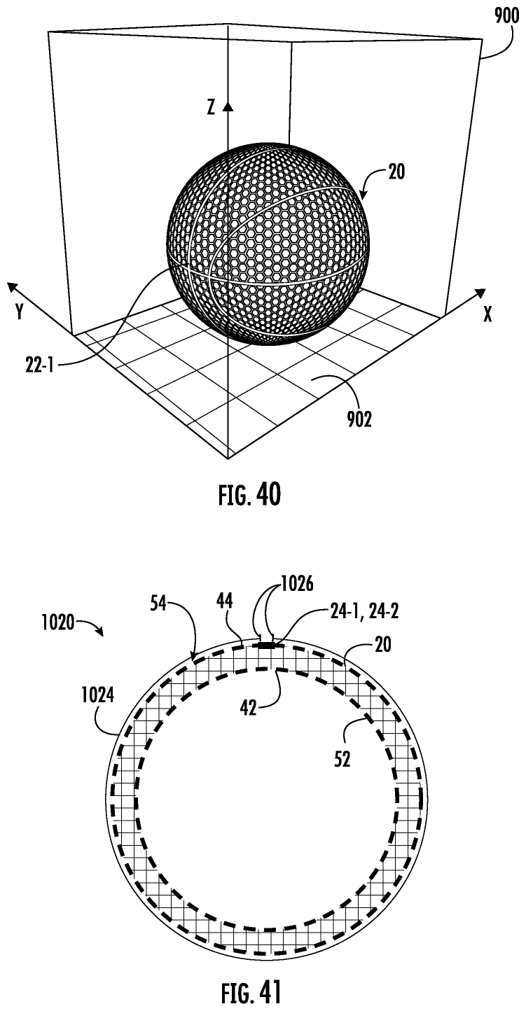

FIGS. 41 and 42 are sectional views schematically illustrating an example basketball 1020 provided with a skin. FIG. 42 illustrates a portion of outer lattice 44 covered by a skin. Basketball 1020 comprises basketball 20 (described above) provided with an outer skin 1024. In some implementations, outer skin 1024 is translucent or transparent to facilitate and maintain the visibility of outer layer 54 of basketball 20. Outer skin 1024 is in close conformal contact with the outer surface of outer layer 54, having a contour profile that matches the outer contour profile of outer surface of outer layer 54. For example, outer skin 1024 may dip in those regions of outer skin 1024 that overlie the recessed surface strips 24, 26, 28 and 30, maintaining the loby shape or profile of the internal basketball 20 and the final skin covered basketball 1020.

Outer skin 1024 may be formed from a durable polymeric material and may be extremely thin so as to have a reduced impact on the overall weight, size and rebound characteristics of basketball 1020. In some implementations, outer skin 1024 may have a thickness of at least 0.3 mm and no greater than 5 mm. In some implementations, outer skin 1024 may have a thickness of less than 1 mm. In some implementations, outer skin 1024 may be formed from material such as thermoplastic polyolefin or thermoplastic/thermoset polyurethane. As shown by FIG. 42, outer skin 1024 may span across the outer circumferential beams 68 of outer lattice 44. Outer skin 1024 may cover the tops 70 of such beams 68. Outer skin 1024 may additionally overlap and cover surface strips 24, 26, 28 and 30 (illustrated in the figures described above).

In some implementations, outer skin 1024 may comprise a single unitary one-piece layer or film having a single set of opposing edges 1026. The opposing edges 1026 may form an opening into which basketball 20 may be inserted. In some implementations, the opposing edges 1026 are aligned with one or more of the surface strips, such as surface strips 24-1, 24-2 (schematically shown in FIG. 41) so as to lessen any variation that may occur along such edges 1026. In some implementations, edges 1026 may be recessed within the recess channel or groove provided by the loby shape of basketball 20.

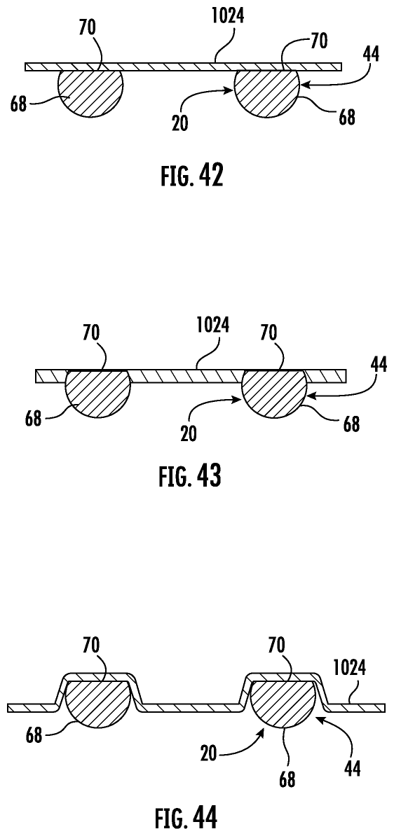

In some implementations, outer skin 1024 may be shrunk wrap about basketball 20. For example, outer skin 1024 may be provided as a film which is wrapped about basketball 20 and was subsequently heated so as to shrink the film into close conformal contact and even fused to the outer surface of outer layer 54. In some implementations, outer skin 1024 may be co-molded about basketball 20. As shown by FIG. 43, in some implementations, outer skin 1024 may be applied to basketball 20 so as to be flush or level with tops 70 of beams 68 of outer lattice 44.

As shown by FIG. 44, in some implementations, outer skin 1024 may be applied to basketball 20 so as to at least partially encapsulate or wrap around circumferential beams 68 of outer lattice 44. This construction may provide a greater surface area for fusion, melting, bonding or adhering of outer skin 1024 to the outer surface of outer layer 54. This construction may also provide a form of a mechanical lock between circumferential beams 68 of outer lattice 44 and outer skin 1024. In some implementations, outer skin 1024 may be pressed against the exterior of basketball 20 with a mold having an interior surface provided with projections that press portions of outer skin 1024 partially into the hexagonal voids of the hexagonal cells formed by circumferential beams 68. In some implementations, a needle may be passed between edges 1026, wherein a vacuum may be applied through the needle to the interior of basketball 20 to suck or draw outer skin 1024 (while in a flexible, pliable or partially melted state) into close conformal contact with the outer surface of outer layer 54 and, in the implementation shown in FIG. 44, to draw portions of outer skin 1024 into the hexagonal cells formed between circumferential beams 68. Thereafter, the needle may be withdrawn, leaving outer skin 1024 either fused to beams 68, mechanically locked to beams 68 and/or bonded to tops 70 and sides of beams 68 (via an adhesive applied to beams 68 prior to the application of outer skin 1024 or applied to a face of outer skin 1024). In such implementations, the interior of the completed basketball 1020, with skin 1024, may be exposed to atmospheric pressure through the openings through which the needle was inserted.

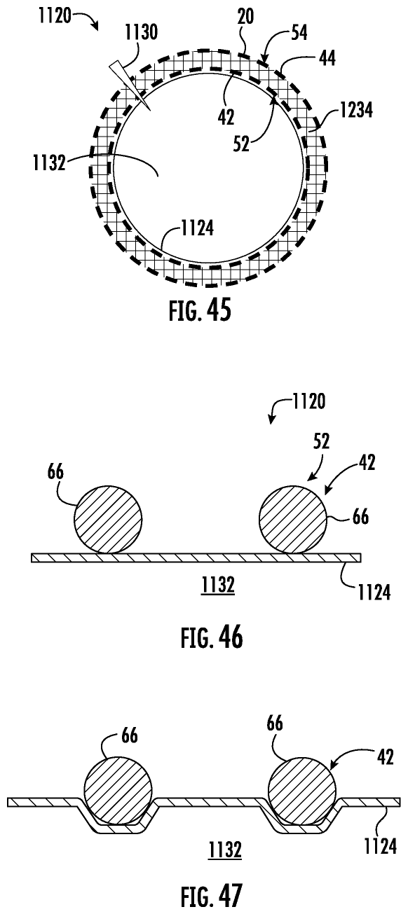

FIGS. 45 and 46 are sectional views schematically illustrating portions of an example basketball 1120 provided with an inner skin 1124. FIG. 46 illustrates a portion of inner lattice 42 covered by or supporting inner skin 1124. Basketball 1120 comprises basketball 20 (described above) provided with an inner skin 1124. In some implementations, inner skin 1124 is translucent or transparent to facilitate and maintain the visibility through and across basketball 20. In some implementations, inner skin 1124 may be opaque. Inner skin 1124 is in close conformal contact with the inner surface of inner layer 52, inner lattice 42, having a contour profile that matches the inner contour profile of inner surface of inner layer 52.

Inner skin 1124 may be formed from a durable polymeric material and may be extremely thin so as to have a reduced impact on the overall weight, size and rebound characteristics of basketball 1120. In some implementations, inner skin 1124 may have a thickness of at least 0.3 mm and no greater than 5 mm. In some implementations, inner skin 1124 may have a thickness of less than 1 mm. In some implementations, inner skin 1124 may be formed from material such as thermoplastic polyolefin or thermoplastic/thermoset polyurethane. As shown by FIG. 46, inner skin 1124 may span across the circumferential beams 66 of inner lattice 42. Inner skin 1124 may cover the interior facing surfaces of such beams 68.

In some implementations, inner skin 1124 may be adhesively bonded to the interior surface of beams 68. For example, an adhesive may be applied to such surfaces of beams 68 or to a face of inner skin 1124. In other implementations, inner skin 1124 may be melted or fused to inner surfaces of beams 66 through the application of heat. As shown by FIG. 45, in some implementations, a cannula, trocar or needle 1130 may be inserted through the open cells formed by outer lattice 44 and inner lattice 42, into the interior 1132 of basketball 20. Thereafter, a collapsed balloon, formed by inner skin 1124, may be inserted through the needle 1130 into the interior and inflated through needle 1130. The collapsed balloon may be inflated to a state such that its outer surface or outer wall (skin 1124) expands and is brought into contact with the inner surface portions of beams 68.

As noted above, in some implementations, skin 1124 is adhesively bonded to beams 68. In other implementations, the gas inflating the balloon may be at a temperature sufficient to heat the wall of the balloon to a temperature to fuse the wall of the balloon (skin 1124) to beams 66. In yet other implementations, heat may be applied to the exterior basketball 20, the heat being insufficient to melt or deformed basketball 20 but being sufficient to melt and fuse skin 1124 to beams 66. Thereafter, needle 1130 may be withdrawn leaving inner skin 1124 either fused to beams 66 and/or bonded to tops 70 and sides of beams 68 (via an adhesive applied to beams 68 prior to the application of outer skin 1024 or applied to a face of outer skin 1024). In such implementations, the interior of the completed basketball 1020, with skin 1124, may be exposed to atmospheric pressure through the openings through which the needle was inserted.

In some implementations, inner skin 1124 may alternatively be injected through needle 1130 along the interior surfaces of layer 52 and inner lattice 42 or may be sprayed onto such surfaces and using needle 1130. The material may be deposited so as to form a continuous and imperforate film across inner lattice 42.

As shown by FIG. 47, in some implementations, the interior 1132 may be inflated through needle 1130 to an extent such projects into the cell formed by beams 66 of inner lattice 42, at least partially wrapping about or encapsulating beams 66. By wrapping skin 1124 at least partially about beams 66, a greater surface area is provided for adhesively bonding or fusing skin 1124 to beams 66 of inner lattice 42. In some implementations, such wrapping, or at least partial encapsulation, may additionally form a mechanical lock to further enhance retention of skin 1124 to beams 66.

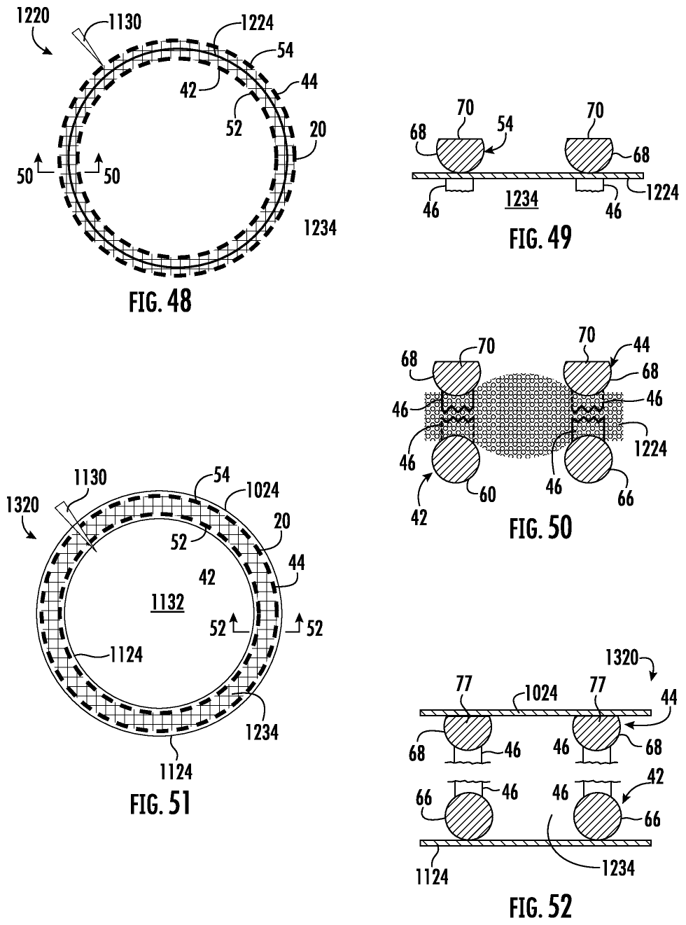

FIGS. 48 and 49 are sectional views schematically illustrating portions of an example basketball 1220 having an intermediate or middle skin 1224. FIG. 49 illustrates middle skin 1224 and circumferential beams 68 of outer lattice 44. Basketball 1220 comprises basketball 20 (described above) provided with middle skin 1224. In some implementations, middle skin 1224 is translucent or transparent to facilitate and maintain the visibility through and across basketball 20. In some implementations, middle skin 1224 may be opaque. Middle skin 1224 is in close conformal contact with the inner surface of inner layer 52, inner lattice 42, having a contour profile that matches the inner contour profile of inner surface of inner layer 52.

Middle skin 1224 may be formed from a durable polymeric material and may be extremely thin so as to have a reduced impact on the overall weight, size and rebound characteristics of basketball 1220. In some implementations, middle skin 1224 may have a thickness of at least 0.3 mm and no greater than 5 mm. In some implementations, middle skin 1224 may have a thickness of less than 1 mm. In some implementations, middle skin 1224 may be formed from material such as thermoplastic polyolefin or thermoplastic/thermoset polyurethane. As shown by FIG. 49, middle skin 1224 may span across the circumferential beams 66 of inner lattice 42. Middle skin 1224 may cover the interior facing surfaces of such beams 68.

In some implementations, middle skin 1224 may be adhesively bonded to the interior surface of beams 68. For example, an adhesive may be applied to such surfaces of beams 68 or to a face of middle skin 1224. In other implementations, middle skin 1224 may be melted or fused to inner surfaces of beams 66 through the application of heat.

As shown by FIG. 48, in some implementations, a cannula, trocar or needle 1130 may be inserted through the open cells formed by outer lattice 44 and into the middle space 1234 circumferentially extending between layers 52 and 54 of basketball 20. Thereafter, a material may be sprayed or jetted into middle space 1234. In some implementations, basketball 20 may be placed within an outer spherical shell formed by two halves) having multiple inwardly facing cannulas, trocars or needles 1130 that simultaneously project through multiple cells of outer lattice 44 about basketball 20, wherein the material may be concurrently jetted into inner space 1234 about basketball 20. Thereafter, the completed basketball may be removed from the outer spherical injection shell, resulting in the multiple needles also being withdrawn.

In some implementations, the material may comprise a fluid. In other implementations, the material may be carried by an aerosol. The material injected by needle 1130 may solidify or coagulate to form skin 1224 which spans across the cells formed by circumferential beams 68. In some implementations, needle 1130 may be inserted through multiple spaced cells of outer lattice 42, wherein the material is injected or sprayed multiple times into inner space 1234 at different locations, wherein the material may bond to itself and overlap or connect along edges to form a continuous middle skin 1224. In some implementations, the material concurrently projected into different portions about basketball 20 by multiple needles 1130.

In some implementations, the material injected by needle 1130 through one of the open cells of outer lattice 44, sequentially through a plurality of the open cells of outer lattice 44 at different locations about basketball 20, or concurrently through a plurality of open cells of outer lattice 44 by multiple needles 1130 at different locations about basketball 20 may instead adhere to or bond to the inner surface of layer 52, the inner surface of inner lattice 42. In such an implementation, the material injected by needle 1130 may not be sufficiently thick to contact the inner surface of outer layer 52.

In yet other implementations, as indicated by FIG. 50, the material injected by needle 1130 through one of the open cells of outer lattice 44 or through different spaced open cells of open lattice 44 at different locations about basketball 20 may have a sufficient thickness so as to contact and bond to both inner layer 52 and outer layer 54, both the outer surface of inner lattice 42 and the inner surface of outer lattice 44. In some implementations, the material injected by needle(s) 1130 may comprise a foam material or a material that once injected expands and foams to form a foamed middle skin 1224. In some implementations, the material may expand to a sufficient degree so as to fill inner space 1234, contacting both inner layer 52 and outer layer 54. For example, the foamed middle skin 1224 may partially wrap about or expand about both the circumferential beams 66 of inner lattice 42 and the circumferential beams 68 of outer lattice 44. In such implementations, the foamed middle skin 1224 may encircle and encapsulate radial beams 46 to further lock and retain the middle layer or skin 1224 in place. In some implementations, the material injected via needle 1130 may be translucent or transparent. In other implementations, the material injected by needle 1130 and forming middle skin 1224 may be opaque.

FIGS. 51 and 52 are sectional views illustrating portions of an example 3D printed basketball 1320. Basketball 1320 comprises basketball 20 (described above) provided with an outer skin 1024 and inner skin 1124 described above. Although outer skin 1024 is illustrated as extending in a circumferential plane across top 70 of beams 68 of outer lattice, similar what is shown in FIG. 42, in some implementations, outer skin 1024 in basketball 1320 may be configured similar to the configuration shown in FIG. 43 or FIG. 44. Although inner skin 1124 is illustrated as extending in a circumferential plane, skimming along the inner surfaces of circumferential beams 66 of inner lattice 42, in some implementations, inner skin 1124 may have a configuration similar to that shown in FIG. 46 or FIG. 47. In yet other implementations, inner space 1234 may additionally be filled with inner skin 1224 as described above with respect to FIGS. 48-50.

In some implementations, the skins 1024, 1124 and 1224 have uniform characteristics and thicknesses. In yet other implementations, different portions of each of the skins 1024, 1124 and 1224 may have different characteristics or different thickness depending upon what portion of the basketball 20 the particular portion of the skin resides. For example, different portions of the same skin may have a different thickness depending upon whether the skin is adjacent to a pole region 22 of the basketball, a side of the basketball. The thickness may be varied in a continuous or in a stepwise fashion to provide the basketball with a more uniform or consistent bounce or rebound. For example, portions of the skin adjacent to the polar regions may be thinner as compared to portions of the skin along the sides of the basketball.

In some implementations, different portions of the same skin may have different chemical compositions or architectures to provide a more uniform rebound or weight distribution for the basketball. For example, with respect to implementations where middle skin 1224 is foamed, selected portions of the middle skin 1224 may have a greater degree of foaming while other portions of middle skin 1224 may have a lower degree of foaming (lesser blowing agent, greater density, a smaller number of or smaller sized cells). In some implementations where different regions of the inner space 1234 concurrently receive And Injected material through different needles (as described above with respect to the spherical shell), the different needles may inject different amounts of material to provide different thickness for the scanning different regions about basketball 20 or may project different materials having different compositions in different regions about basketball 20.

In the example illustrated, each of the skins 1024, 1124 and 1224 may be transparent or translucent to permit viewing of the inner lattice 42 and the outer lattice 44. In some implementations, the skins may be translucent with one or more colors or color shades, allowing one to see through the skins, but wherein the skins have a color. In some implementations, the skins may include information, such as branding or logos. In some implementations, any of the skins may have different colored portions or simulated seams or joints so as to aesthetically appear as separate panels even though such skins are each a single continuous unitary film or sheet. In some implementations, such skins may be customized to provide graphics, personalized information or team information, training marks or the like. In some implementations, the skins may be personalized with a player's name, a player's team, a particular year, a league name or the like. In some implementations, the intermediate or middle skin 1224 may be opaque and be provided with portions with different colors, graphics or the like. In some implementations, the outer skin 1024 may be textured for example, the outer skin may have an outer surface provided with a pebble-like texture extending across an entire outer surface area of the outer skin 1024, extending in those regions that overlap or overlie the surface strips 24, 26, 28 and 30, extending in those regions that extend between the surface strips 24, 26, 28 and 30 (the simulated panel 32).

In some implementations, surface strips 24, 26, 28 and 30 may be omitted. In such implementations, radial beams 46 may have a uniform height and thickness along the entirety of the outer wall 40. In such implementations, the basketball may be provided with a single continuous outer skin similar to that shown in FIGS. 42-44, wherein outer skin (similar to outer skin 1024) includes opaque or dark lines having the same pattern as that of surface strips 24, 26, 28 and 30 such that the ball appears as a standard basketball. In some implementations, an entirety of the skin or the lines representing the surface strips may be textured. In some implementations, those portions of the skin between the dark lines representing the surface strips may be textured.

Although the claims of the present disclosure are generally directed to a basketball, at least portions of which may be 3D printed, the present disclosure is additionally directed to the features set forth in the following definitions.
1. A basketball comprising:
   a single integrally formed unitary body comprising:
      first layer comprising an inner lattice;
      second layer comprising an outer lattice and surface strips; and
      radial beams interconnecting the first layer and the second layer.
2. The basketball of definition 1, wherein the outer lattice is lobular with a plurality of lobes joined along the surface strips.
3 The basketball of definition 2, wherein the radial beams comprise a first number of the radial beams interconnecting the first layer and the second layer beneath the surface strips and a second number of the radial beams interconnecting the first layer and the second layer circumferentially between the surface strips and wherein each of the first number of radial beams has a first height and wherein each of the second number of radial beams has a second height greater than the first height.
4. The basketball of definition 3, wherein each of the first number of radial beams has a first thickness and wherein each of the second number of radial beams has a second thickness less than the first thickness.
5. The basketball of definition 4, wherein the radial beams comprise a third number of the radial beams interconnecting the first layer and the second layer in circumferential regions between the surface strip, each of the third number of radial beams having the second height and a third thickness greater than the second thickness.
6. The basketball of definition 5, wherein the third thickness is less than the first thickness.
7. The basketball of definition 6, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
8 The basketball of definition 2, wherein the radial beams comprise a first number of the radial beams interconnecting the first layer and the second layer inward of the surface strips and a second number of the radial beams interconnecting the first layer and the second layer circumferentially between the surface strips and wherein each of the first number of radial beams has a first thickness and wherein each of the second number of radial beams has a second thickness less than the first thickness.
9. The basketball of definition 8, wherein the radial beams comprise a third number of the radial beams interconnecting the first layer and the second layer in circumferential regions between the surface strip, each of the third number of radial beams having the second height and a third thickness greater than the second thickness.
10. The basketball of definition 9, wherein the third thickness is less than the first thickness.
11. The basketball of definition 10, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
12. The basketball of definition 11, wherein the inner lattice is spherical and non-lobular.
13. The basketball of definition 11, wherein the inner lattice is lobular.
14. The basketball of definition 17, wherein the radial beams comprise a third number of the radial beams interconnecting the first layer and the second layer in circumferential regions between the surface strip, each of the third number of radial beams having the second height and a third thickness greater than the second thickness.
15. The basketball of definition 18, wherein the third thickness is less than the first thickness.
16. The basketball of definition 15, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
17. The basketball of definition 1, wherein the radial beams comprise a first number of the radial beams interconnecting the first layer and the second layer inward of the surface strips and a second number of the radial beams interconnecting the first layer and the second layer circumferentially between the surface strips and wherein each of the first number of radial beams has a first thickness and wherein each of the second number of radial beams has a second thickness less than the first thickness.
18. The basketball of definition 17, wherein the radial beams comprise a third number of the radial beams interconnecting the first layer and the second layer in circumferential regions between the surface strip, each of the third number of radial beams having the second height and a third thickness greater than the second thickness.
19. The basketball of definition 18, wherein the third thickness is less than the first thickness.
20. The basketball of definition 19, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
21. The basketball of definition 20, wherein the inner lattice is spherical and non-lobular.
22. The basketball of definition 20, wherein the inner lattice is lobular.
23. The basketball of definition 1, wherein the inner lattice is spherical and non-lobular.
24. The basketball of definition 1, wherein the inner lattice is lobular.
25. The basketball of according to any of the above definitions, wherein the radial beams have a thickness of at least 3 mm.
26. The basketball according to any of the above definitions, wherein the outer lattice comprises outer lattice beams having flat outer surfaces.
27. The basketball according to any of the above definitions, wherein the inner lattice comprises inner lattice beams having oval cross-sections.
28. The basketball according to any of the above definitions, wherein the radial beams have a thickness of at least 0.8 mm and no greater than 3.5 mm.
29. The basketball according to any of the above definitions, wherein the radial beams have a uniform thickness between the inner lattice and the outer lattice.
30. The basketball according to any of the above definitions, wherein the radial beams have a non-uniform thickness between the inner lattice and the outer lattice.
31. The basketball according to any of the above definitions, wherein the inner lattice and the outer lattice each comprise a two-dimensional hexagonal lattice.
32. The basketball according to any of the above definitions, wherein the outer lattice comprises eight lobes, each lobe having a smaller radius of curvature as compared to an overall radius of the basketball.
33. The basketball according to any of the above definitions, wherein the inner lattice and the outer lattice comprise cells having a center-to-center distance of at least 5 mm and no greater than 12 mm.
34. The basketball according to any of the above definitions, wherein the inner lattice comprises inner lattice beams having a thickness of at least 1 mm and no greater than 5 mm and wherein the outer lattice comprises outer lattice beams having a thickness of at least 0.8 mm and no greater than 3.5 mm.
35. The basketball according to any of the above definitions, wherein the single integrally formed unitary body is formed from a material having material properties, measured as injection molded, of:
   a density of at least 0.9 g/cm³ and no greater than 1.2 g/cm³, a shore A durometer of at least 80 and no greater than 92; a flexural modulus of at least 80, a tensile modulus of at least 50, and elongation percentage of at least 150% and a rebound resilience of at least 50% as measured pursuant to ASTM D7121/DIN 53512 DIN 53516.
36. The basketball according to any of the above definitions further comprising a single outer skin enveloping the outer lattice.
37. The basketball of definition 36, wherein the single skin is imperforate.
38. The basketball according to either definitions 36 or 37, wherein the skin has skin edges, the skin edges aligned with one of the surface strip.
39. The basketball according to any of definitions 36-38, wherein the skin is transparent or translucent.
40. The basketball according to any of definitions 36-39, wherein the skin at least partially encapsulates outer lattice beams of the outer lattice.
41. The basketball according to any of definitions 1-35 further comprising an inner skin formed on an inner surface of one of the inner lattice and the outer lattice.
42. The basketball according to any of the above definitions further comprising a surface coating logo on an outer surface of the outer lattice.
43. The basketball according to any of the above definitions further comprising a three-dimensional logo formed on one of the surface strip.
44. The basketball according to any of the above definitions, wherein one of the surface strips has a widened portion and wherein the basketball further comprises a three-dimensional logo formed on the widened portion.
45. The basketball of definition 44, wherein the widened portion is located at a pole center of the basketball.
46. The basketball of definition 44, wherein the widened portion is spaced from poles of the basketball.
47. The basketball according to any of the above definitions, wherein the basketball has a circumference of at least 742 mm and no greater than seven and 59 mm, a mass of at least 567 g and no greater than 628 g, and a rebound of at least 52 inches and no greater than 53 inches.
48. The basketball according to any of the above definitions, wherein the outer lattice comprises an outer textured surface.
49. The basketball according to any of the above definitions, wherein the surface strips have an outer textured surface.
50. The basketball according to any of the above definitions, wherein the basketball has a circumference of at least 742 mm and no greater than seven and 59 mm, a mass of at least 567 g and no greater than 628 g, and a rebound of at least 52 inches and no greater than 53 inches.
51. The basketball according to any of the above definitions, wherein the outer lattice comprises an outer textured surface.
52. The basketball according to any of the above definitions, wherein the surface strips have an outer textured surface.
53. A basketball comprising:
   a single integrally formed unitary body comprising:
      a first layer comprising an inner lattice;
      a second layer comprising an outer lattice; and
      radial beams interconnecting the first layer and the second layer; and
   a single outer skin enveloping the outer lattice.
54. The basketball of definition 53, wherein the single outer skin is imperforate.
55. The basketball according to either definitions 53 or 54, wherein the second layer comprises surface strips and wherein the wherein the single outer skin has skin edges, the skin edges aligned with one of the surface strips.
56. The basketball according to any of definitions 53-55, wherein the single outer skin is transparent or translucent.
57. The basketball according to any of definitions 53-55, wherein the single outer skin at least partially encapsulates outer lattice beams of the outer lattice.
58. The basketball according to any of definitions 53-57 further comprising an inner skin formed on an inner surface of one of the inner lattice and the outer lattice.
59. The basketball according to any of the above definitions, wherein the basketball has a circumference of at least 742 mm and no greater than seven and 59 mm, a mass of at least 567 g and no greater than 628 g, and a rebound of at least 52 inches and no greater than 53 inches.
60. The basketball according to any of the above definitions, wherein the outer lattice comprises an outer textured surface.
61. The basketball according to any of the above definitions, wherein the surface strips have an outer textured surface.
62. A basketball comprising:
   a single integrally formed unitary body comprising:
      an inner lattice;
      an outer lattice; and
      radial beams interconnecting the inner lattice and the outer lattice; and
   an inner skin covering an inner surface of the inner lattice.
63. The basketball of definition 62, wherein the inner skin is spherical and has an interior at atmospheric pressure.
64. The basketball of definition 62, wherein the inner skin protrudes through openings of the inner lattice towards the outer lattice.
65. The basketball according to any of the above definitions 62-64, wherein the basketball has a circumference of at least 742 mm and no greater than seven and 59 mm, a mass of at least 567 g and no greater than 628 g, and a rebound of at least 52 inches and no greater than 53 inches.
66. The basketball according to any of the above definitions 62-65, wherein the outer lattice comprises an outer textured surface.
67. The basketball according to any of the above definitions 62-66, wherein the surface strips have an outer textured surface.
68. A method for forming a basketball, the method comprising:
   printing a single integral unitary spherical body comprising:
      a first layer comprising an inner lattice;
      a second layer comprising an outer lattice and surface strips that converge at opposite poles of the spherical body,
   wherein the spherical body is printed in a powder containing volume that horizontally extends in X and Y axes and that vertically extends in a z-axis and wherein the opposite poles of the spherical body are aligned in the X and Y axes during printing.
69. The method of definition 68, wherein the outer lattice is lobular with a plurality of lobes joined along the surface strips.
70. The method of definition 69, wherein the radial beams comprise a first number of the radial beams interconnecting the first layer and the second layer beneath the surface strips and a second number of the radial beams interconnecting the first layer and the second layer circumferentially between the surface strips and wherein each of the first number of radial beams has a first height and wherein each of the second number of radial beams has a second height greater than the first height.
71. The method of definition 70, wherein each of the first number of radial beams has a first thickness and wherein each of the second number of radial beams has a second thickness less than the first thickness.
72. The method of definition 71, wherein the radial beams comprise a third number of the radial beams interconnecting the first layer and the second layer in circumferential regions between the surface strip, each of the third number of radial beams having the second height and a third thickness greater than the second thickness.
73. The method of definition 72, wherein the third thickness is less than the first thickness.
74. The method of definition 73, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
75. The method of definition 69, wherein the radial beams comprise a first number of the radial beams interconnecting the first layer and the second layer inward of the surface strips and a second number of the radial beams interconnecting the first layer and the second layer circumferentially between the surface strips and wherein each of the first number of radial beams has a first thickness and wherein each of the second number of radial beams has a second thickness less than the first thickness.
76. The method of definition 75, wherein the radial beams comprise a third number of the radial beams interconnecting the first layer and the second layer in circumferential regions between the surface strip, each of the third number of radial beams having the second height and a third thickness greater than the second thickness.
77. The method of definition 76, wherein the third thickness is less than the first thickness.
78. The method of definition 77, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
79. The method of definition 78, wherein the inner lattice is spherical and non-lobular.
80. The method of definition 78, wherein the inner lattice is lobular.
81. The method of definition 75, wherein the radial beams comprise a third number of the radial beams interconnecting the first layer and the second layer in circumferential regions between the surface strip, each of the third number of radial beams having the second height and a third thickness greater than the second thickness.
82. The method of definition 81, wherein the third thickness is less than the first thickness.
83. The method of definition 82, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
84. The method of definition 68, wherein the radial beams comprise a first number of the radial beams interconnecting the first layer and the second layer inward of the surface strips and a second number of the radial beams interconnecting the first layer and the second layer circumferentially between the surface strips and wherein each of the first number of radial beams has a first thickness and wherein each of the second number of radial beams has a second thickness less than the first thickness.
85. The method of definition 84, wherein the radial beams comprise a third number of the radial beams interconnecting the first layer and the second layer in circumferential regions between the surface strip, each of the third number of radial beams having the second height and a third thickness greater than the second thickness.
86. The method of definition 85, wherein the third thickness is less than the first thickness.
87. The method of definition 86, wherein the surface strips converge at opposite poles of the basketball and wherein the radial beams interconnecting the first layer and the second layer comprise a fourth number of the radial beams forming cap regions at the opposite poles and having a fourth thickness less than the first thickness and less than the third thickness.
88. The method of definition 87, wherein the inner lattice is spherical and non-lobular.
89. The method of definition 87, wherein the inner lattice is lobular.
90. The method of definition 68, wherein the inner lattice is spherical and non-lobular.
91. The method of definition 68, wherein the inner lattice is lobular.
92. The method of according to any of the above definitions 68-91, wherein the radial beams have a thickness of at least 3 mm.
93. The method according to any of the above definitions 68-92, wherein the outer lattice comprises outer lattice beams having flat outer surfaces.
94. The method according to any of the above definitions 68-93, wherein the inner lattice comprises inner lattice beams having oval cross-sections.
95. The method according to any of the above definitions 68-94, wherein the radial beams have a thickness of at least 0.8 mm and no greater than 3.5 mm.
96. The method according to any of the above definitions D8-95, wherein the radial beams have a uniform thickness between the inner lattice and the outer lattice.
97. The method according to any of the above definitions 68-96, wherein the radial beams have a non-uniform thickness between the inner lattice and the outer lattice.
98. The method according to any of the above definitions, wherein the inner lattice and the outer lattice each comprise a two-dimensional hexagonal lattice.
99. The method according to any of the above definitions, wherein the outer lattice comprises eight lobes, each lobe having a smaller radius of curvature as compared to an overall radius of the basketball.
100. The method according to any of the above definitions 68-99, wherein the inner lattice and the outer lattice comprise cells having a center-to-center distance of at least 5 mm and no greater than 12 mm.
101. The method according to any of the above definitions 68-100, wherein the inner lattice comprises inner lattice beams having a thickness of at least 1 mm and no greater than 5 mm and wherein the outer lattice comprises outer lattice beams having a thickness of at least 0.8 mm and no greater than 3.5 mm.
102. The method according to any of the above definitions 68-101, wherein the single integrally formed unitary body is formed from a material having material properties, measured as injection molded, of:
   a density of at least 0.9 g/cm³ and no greater than 1.2 g/cm³, a shore A durometer of at least 80 and no greater than 92; a flexural modulus of at least 80, a tensile modulus of at least 50, and elongation percentage of at least 150% and a rebound resilience of at least 50% as measured pursuant to ASTM D7121/DIN 53512 DIN 53516.
103. The method according to any of the above definitions 16-102 further comprising enveloping the outer lattice with a single outer skin.
104. The method of definition 103, wherein the single skin is imperforate.
105. The method according to either definitions 103 or 104, wherein the skin has skin edges, the skin edges aligned with one of the surface strip.
106. The method according to any of definitions 103-105, wherein the skin is transparent or translucent.
107. The method according to any of definitions 103-106, wherein the skin at least partially encapsulates outer lattice beams of the outer lattice.
108. The method according to any of definitions 68-102 further comprising forming an inner skin formed on an inner surface of one of the inner lattice and the outer lattice.
109. The method according to any of the above definitions 68-108 further comprising a surface coating logo on an outer surface of the outer lattice.
110. The method according to any of the above definitions 68-108 further comprising a three-dimensional logo formed on one of the surface strip.
111. The method according to any of the above definitions 68-108, wherein one of the surface strips has a widened portion and wherein the basketball further comprises a three-dimensional logo formed on the widened portion.
112. The method of definition 111, wherein the widened portion is located at a pole center of the basketball.
113. The method of definition 111, wherein the widened portion is spaced from poles of the basketball.
114. The method according to any of the above definitions 68-113, wherein the basketball has a circumference of at least 742 mm and no greater than seven and 59 mm, a mass of at least 567 g and no greater than 628 g, and a rebound of at least 52 inches and no greater than 53 inches.
115. The method according to any of the above definitions 68-114, wherein the outer lattice comprises an outer textured surface.
116. The method according to any of the above definitions 68-115, wherein the surface strips have an outer textured surface.
117. The method according to any of the above definitions 68-116, wherein the basketball has a circumference of at least 742 mm and no greater than seven and 59 mm, a mass of at least 567 g and no greater than 628 g, and a rebound of at least 52 inches and no greater than 53 inches.
118. The method according to any of the above definitions 68-117, wherein the outer lattice comprises an outer textured surface.

The method according to any of the above definitions 68-118, wherein the surface strips have an outer textured surface.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A basketball comprising:
a single integrally formed unitary body comprising:
first layer comprising an inner lattice;
second layer comprising an outer lattice and surface strips; and
radial beams interconnecting the first layer and the second layer.

2. The basketball of claim 1, wherein the outer lattice is lobular with a plurality of lobes joined along the surface strips.

3. The basketball of claim 2, wherein the radial beams comprise a first number of the radial beams interconnecting the first layer and the second layer beneath the surface strips and a second number of the radial beams interconnecting the first layer and the second layer circumferentially between the surface strips and wherein each of the first number of radial beams has a first height and wherein each of the second number of radial beams has a second height greater than the first height.

4. The basketball of claim 3, wherein each of the first number of radial beams has a first thickness and wherein each of the second number of radial beams has a second thickness less than the first thickness.

5. The basketball of claim 4, wherein the radial beams comprise a third number of the radial beams interconnecting the first layer and the second layer in circumferential regions between the surface strip, each of the third number of radial beams having the second height and a third thickness greater than the second thickness.

6. The basketball of claim 1, wherein the radial beams comprise a first number of the radial beams interconnecting the first layer and the second layer inward of the surface strips and a second number of the radial beams interconnecting the first layer and the second layer circumferentially between the surface strips and wherein each of the first number of radial beams has a first thickness and wherein each of the second number of radial beams has a second thickness less than the first thickness.

7. The basketball of claim 1, wherein the inner lattice is spherical and non-lobular.

8. The basketball of claim 1, wherein the inner lattice is lobular.

9. The basketball according to any of the above claims, wherein the outer lattice comprises outer lattice beams having flat outer surfaces.

10. The basketball according to claim 1, wherein the radial beams have a uniform thickness between the inner lattice and the outer lattice.

11. The basketball according to claim 1, wherein the inner lattice and the outer lattice each comprise a two-dimensional hexagonal lattice.

12. The basketball according to claim 1, wherein the inner lattice and the outer lattice comprise cells having a center-to-center distance of at least 5 mm and no greater than 12 mm.

13. The basketball according claim 1, wherein the inner lattice comprises inner lattice beams having a thickness of at least 1 mm and no greater than 5 mm and wherein the outer lattice comprises outer lattice beams having a thickness of at least 0.8 mm and no greater than 3.5 mm.

14. The basketball according to claim 1, wherein the single integrally formed unitary body is formed from a material having material properties, measured as injection molded, of:
a density of at least 0.9 g/cm³ and no greater than 1.2 g/cm³, a shore A durometer of at least 80 and no greater than 92; a flexural modulus of at least 80, a tensile modulus of at least 50, and elongation percentage of at least 150% and a rebound resilience of at least 50% as measured pursuant to ASTM D7121/DIN 53512 DIN 53516.

15. The basketball according to claim 1 further comprising an outer skin over an outer surface of the outer lattice.

16. The basketball of claim 15, wherein the outer skin is imperforate.

17. The basketball according to claim 15, wherein the skin is transparent or translucent.

18. The basketball according to claim 1 further comprising an inner skin formed on an inner surface of one of the inner lattice and the outer lattice.

19. The basketball according to claim 1, wherein the outer lattice comprises an outer textured surface.

20. The basketball according to claim 1, wherein the basketball has a circumference of at least 742 mm and no greater than seven and 59 mm, a mass of at least 567 g and no greater than 628 g, and a rebound of at least 52 inches and no greater than 53 inches.
